(19) United States
(12) Patent Application Publication
(10) Pub. No.: US 2014/0207486 A1
(43) Pub. Date: Jul. 24, 2014

(54) HEALTH MANAGEMENT SYSTEM

(71) Applicants: Martin Carty, Wayne, PA (US); Michael Helfrich, Swampscott, MA (US)

(72) Inventors: Martin Carty, Wayne, PA (US); Michael Helfrich, Swampscott, MA (US)

(73) Assignee: LIFEGUARD HEALTH NETWORKS, INC., Wayne, PA (US)

(21) Appl. No.: 14/240,942

(22) PCT Filed: Aug. 31, 2012
(86) PCT No.: PCT/US12/53550

§ 371 Date: Feb. 25, 2014

Related U.S. Application Data
(60) Provisional application No. 61/529,809, filed on Aug. 31, 2011.

(51) Int. Cl. G06Q 50/22; G06Q 10/10

(52) U.S. Cl. CPC G06Q 50/22; G06Q 10/10
USPC 705/2

(57) ABSTRACT

A decentralized system with at least a server (130, 140) and a plurality of remote devices including at least a member device (150), a caregiver device (120) and a support device (110) configured for use by a at least one person in a support team network for a user of the member device. The system is configured to allow the server and the remote devices to communicate over a network to define a continuity of care network (CCN 100) for managing the flow of member related information between the member device (150), the caregiver device (120) and the support device (110); receive behavioral change communications in response to health events related to the member; and transmit communications regarding the received behavioral change communications to at least one user of the member device (150), the caregiver device (120) and the support device (110).

### FIELD

The technology described in this patent document relates to decentralized, member-activated networks for continuity of care, health management and intervention insettings independent of location.

### BACKGROUND

Mobile health, also referred to as mHealth, refers to the use of mobile devices, such as mobile phones, personal digital assistants (“PDAs”), tablets, personal computers and the like, to implement health services.

An element of an mHealth system is data capture. Companies have provided data capture capabilities in the past. For example, Health Hero™ provides a “telehealth” appliance, Health Buddy™, for in-home health management. Health Buddy™ collects various data elements by presenting questions as daily observations to the member and logging the answers and/or by connecting various meters and monitors, such as blood glucose meters, weight scales, blood pressure cuffs, and the like to receive data for the member. This information is then passed from the appliance (i.e., a fixed station technology platform) to a central station for processing to the medical practitioner.

An element of some mHealth systems is a remote member monitoring (“RPM”) service. Companies have provided mobility based telemetry and remote member monitoring systems in the past. For example, CARDIONET™ provides a Mobile Cardiac Outmember Telemetry system and device that allow a medical practitioner to monitor remotely a member's electrocardiogram (“ECG”) data. This may allow the practitioner to receive trending data to assist with diagnosing and treating the member.

Another element of an mHealth system is a rules-based (i.e., expert) service. Over the past few years, companies have defined therapeutic content mapped to rules-based logic to ensure proper compliance to medical regiment. By way of example, WellDoc™ provides an expert based system for diabetes care and regiment managemenUsers leverage a pre-defined set of therapeutic care procedures and thresholds for alerts and notifications over a mobile-based platform configured by their medical practitioners. Promised benefits include improved compliance and health responsiveness from collective caregiver team.

Mobile collaboration is a technology-based process of communicating that utilizes electronic assets and accompanying software designed for use in remote locations as well as at different times. The newest generation hand-held electronic devices feature video and audio capabilities broadcast over secure networks, enabling multi-party conferencing in real time. SKYPE™ is an exemplary mobile collaboration solution that has connectivity to the internet and provides multi-party conferencing capabilities. Mobile collaboration often utilizes wireless, cellular, and broadband technologies to enable collaboration independent of location.

Service management may be integrated into supply chain management to bridge between the product and/or service and the customer. The aim of high performance service management is to optimize the service-intensive supply chains. Most service-intensive supply chains require tighter integration with field service and third parties to support the end customer. They also must accommodate inconsistent and uncertain demand by establishing more advanced information and product flows. Moreover, all processes should be coordinated across numerous service locations with large numbers of participants and multiple levels in the supply chain.

Case management is a collaborative practice model including users, nurses, social workers, physicians, other practitioners, caregivers and the community The case management process encompasses communication and facilitates care along a continuum through resource coordination. Vendors offering case management software and services include GE, Cerner, McKesson, Epic, all Scripts, and Eclipsys. The goals of Case Management include the achievement of optimal health, access to care and appropriate utilization of resources, balanced with the member's right to self-determination. Case management responsibilities include the following functions:
Advocacy & Education—ensuring the member has an advocate for needed services and any needed education
Clinical Care Coordination/Facilitation—coordinating multiple aspects of care to ensure the member progresses
Continuity/Transition Management—transitioning of the member to the appropriate level of care needed
Performance & Outcomes Management—monitoring, and if needed, intervening to achieve desired goals and outcomes for both the member and the hospital
Psychosocial Management—assessing and addressing psychosocial needs including individual, familial, environmental, etc.
Research & Practice Development—identifying practice improvements and using evidence based data to influence needed practice changes

Incident Management Systems provide event activated networks for coordination, event handling, and triage. For example, FirstAlert and GM's OnStar are examples of emergency responses platforms. FirstAlert provides a member activated alarm—a radio frequency transmitter mounted on a necklace for example—that sends a signal via a home telephone line to a call center for triage. GM's OnStar system is a CPU based platform attached to an automobile's CPU which monitors all system sensors and when a threshold value is passed, passes the information onto the OnStar system which in turn sends the notifications to a call center for triage. However, current incident management systems are limited by requiring hardware integrating the incident management system with special use devices (e.g., a necklace or an automobile).

### SUMMARY

This disclosure relates to a system comprises of at least one server which can be configured to communicate with a plurality of remote devices over a network. The system comprises of the remote devices which includes at least a member device, a caregiver device, and a support device which can be configured for use by at least one person in a trusted care team for a user of the member device. Enable a continuity of care network for managing the flow of member related information between the member device, the caregiver device, and the support device. In addition, receive behavioral change communications in response to health events related to the member and facilitate transmission of communications regarding the received behavioral change communications to at least one user of the member device, the caregiver device, and the support device.

The system comprises of at least one of the servers which can be configured to receive requests to add/remove users in the continuity of care network to thereby create the trusted care team of a member. In addition, the system comprises of at least one of the remote devices which can be a mobile or fixed-wire computing device. Further, the system comprises of at least one of the servers which can be in a cloud computing environment and a proprietary private network.

The system further comprises of the continuity of care network is governed by a defined member-centered health services model including a plurality of rules.

In addition, the system comprises of the rules that can be rules for at least one of the group. The system consist of evaluating parameters of Rx, Px, or other daily observation, escalating and workflow rules at least one health event, providing at least one behavioral change communications to members of the trusted care team, escalating parameters that initiate a problem and/or case, and automated requests for payer authorization.

The system also comprises of the member device which can be configured to receive member biometric related data from at least one external device and to communicate the received biometric data with the continuity of care network. In addition, the system comprises of at least one of the remote devices which can be configured to communicate member related biometric data directly to at least one other remote device. The system further comprising of a primary care provider system configured to receive member data from at least one remote device.

The system comprises of the member data which can include at least one substantially real-time member data, periodic member data reports, aperiodic member data reports, and trending data.

Further, the system comprises of at least one server in the cloud computing environment which can be configured to communicate with at least one autonomous agent configured to monitor data received from member remote device.

In addition, the system comprises of the autonomous agent which can be further configured to respond to member data according to a health service model.

The system also comprises of the autonomous agent's response which can include causing transmission of at least one message, control signal to a member device, control signal to other event routines, and communication to escalation policies and workflows.

The system further comprises of health service policy which can be local and configured to managed the member health communications and events.

The system comprises of the health service policy which can be further configured, for at least one member device, to accomplish at least one triggering appropriate responses received health events and detecting member events and escalating the events according to a health services model if a member device goes off-line.

In addition, the system comprises of at least one of the remote devices which can be configured to store member data. Also, the system comprises of at least one of the servers and at least one of the remote devices are further configured to facilitate one-to-many communications to notify members of the trusted care team of a compliance policy or event.

This disclosure further relates to a system comprises of at least one server which can be configured to distribute health-related information to members of a trusted care team, the trusted care team including at least a member and a health services provider, and distribute at least one communication to members of the trusted care team related to the health of the member.

The system comprises of the communication which can include at least one xml message, text message, and email. In addition, the system comprises of the trusted care team further includes at least one of professional caregivers, personal caregivers, experts, and social medical networks.

The system further comprises of the distributed health-related information which can include at least one daily observation, medical record, lab result, schedule, appointment, billing information, and insurance information related to the member.

In addition, the system further comprises of a member device for monitoring member data, wherein the member device can be configured to communicate with the trusted care team.

The system also comprises of the distribution which can include distribution to at least one mobile or fixed wire computing device.

Further, the system comprises of at least one of the servers can be in a cloud computing environment and in a proprietary private network.

This disclosure also relates to a system comprises of further configured to generate an acknowledgement (ACK) that when activated by a member signals at least one of the member, another member and the activating member's caregiver network of a notification.

The system comprises of the ACK enables at least one of the group consisting of member consent, billing, account update, disease component update, compliance actions, escalation notifications, and as feeders to performance management algorithms.

The technology described herein relates to a communications network for decision support, intervention, and continuity of care amongst a user-centered team of collaborators in a way that provides contextual awareness relative to health related protocols, activities and/or events in support of a user or a set of users. A communication system described here can provide real-time communications, the correlation and escalation of health events, and the analysis of health trends and patient compliance for clinicians and caregivers. A communications system that provides for secure data exchange and problem escalation via a secure wireless network in order to enhance health collaboration and decision making amongst an interdisciplinary team of remote collaborators. A communication system that drives all functions of health management and continuity of care horizontally across a trusted team network of caregivers and interdisciplinary healthcare professionals. A communication system with the capacity to concurrently drive information and incremental decisions and reaction data to all of the member participants, with each participant's information privileges governed by Health Service Management logic comprised of policies, rules, permissions, resource registry, actions, workflows, process indicators, and escalators—independently and individually determined.

The system enabled by software running on a plurality of devices containing a central processing unit (“CPU”) utilizing wireless, cellular, broadband and/or wired communication technologies governed by a knowledge based, work-flow automated health service management (“HSM”) framework enables real-time collaboration and/or intervention in health events and/or trending cases that may have immediate and long term impact for users' compliance and regimen adherence by leveraging the layers of protection built into the system and within the dynamic, trusted social network of caregiver support. The Health Service Management framework coupled with the physician integrated, user-centered health dashboards provide a 360 degree view of patient interactions and caregiver response in a fully transferable electronic health record.

The system provides a core set of health service protocols which are leveraged by application logic and workflow resident on smartphones, wireless computing devices, and/or fixed wire computing devices integrated into an encrypted communications and sensor fusion platform for decision support and health intervention. The secure wireless network is formed from a plurality of mobile or fixed wire computing devices including but not limited to smartphones, mobile devices, personal computers, personal gaming systems, and onboard automotive computing systems.

Each computing device is governed by a proprietary algorithm for based on specific disease protocols for event management and escalation. The system provides secure, real-time event monitoring, correlation and escalation based upon physiological vitals, therapeutic regimen, behavioral communications, and lifestyle events supporting effective health collaboration and decision support for triage and intervention by a team of trusted caregivers and healthcare professionals. The system also provides a comprehensive set of data elements supporting business analytics on health compliance and quality of service.

The system further provides the healthcare professional added features, including optional bi-directional integration between any on-site clinical informatics systems managing electronic medical records within the hospital setting as well as with a health institution's data mart for business analytics. This enables the healthcare professional to make decisions and administer care within existing processes thereby reducing possible eliminating redundancy in data entry and resource utilization.

### BRIEF DESCRIPTION OF THE DRAWINGS

FIG. 1 illustrates an exemplary overview of the continuity of care network (“CCN”) according to this disclosure.

FIG. 2 shows a functional diagram of an exemplary fusion engine useful in the CCN of FIG. 1.

FIG. 3 shows an exemplary process flow for a member's physician to onboard a member into a CCN.

FIG. 4 shows an exemplary member onboarding interface in which a physician may enter information for member onboarding.

FIG. 5A shows an exemplary process flow for member onboarding.

FIG. 5B shows an exemplary process flow for member activation of trusted caregiver team (“TCT”) members.

FIG. 6 shows how team members in an exemplary TCT interact.

FIG. 7 is an exemplary schematic diagram of a health service management (“HSM”) system.

FIGS. 8A and 8B are examples of how a Health Service Policy may be introduced.

FIG. 9 is a simplified schematic of the functions illustrated in FIG. 7.

FIGS. 10-16 show exemplar workflows for performing of various functions of the HSM system.

FIG. 17 shows exemplary badges that may be awarded to various members of a member's TCT.

FIG. 18 shows an exemplary system overview of a member-activated mobile health network similar to the CCN shown in FIG. 1.

FIG. 19 shows an exemplary topology of a CCN utilizing a fusion agent.

FIG. 20 shows and exemplary functional stack and functional interfaces for embodiments to run on top of a fusion agent.

FIG. 21 shows an exemplary workflow for embodiments to provide trending reports, for example to a primary care provider.

FIG. 22 shows an exemplary system for member on-boarding which could, for example implement the process illustrated in FIGS. 3 to 5A/5B.

FIGS. 23-36 illustrate various exemplary user interfaces on a mobile device to allow a member to interact with their computing device, to display data to a member, to interact with a payer or provider, and to interact with other devices in a CCN.

FIG. 37 illustrates an exemplary workflow for providing real-time point-of-consumption metrics for member supply chain consumption reporting.

FIG. 38 illustrates an exemplary workflow for providing real-time point-of-care pharmaceutical efficacy metrics.

FIG. 39 shows an exemplary computing device useful for performing processes disclosed herein.

### DETAILED DESCRIPTION

### (a) Introduction

The system described herein is enabled by software running on a plurality of devices containing a central processing unit (“CPU”) utilizing wireless, cellular, broadband and/or wired communication technologies governed by a knowledge based, work-flow automated health service management (“HSM”) framework. It enables real-time or near real-time collaboration and/or intervention in health events and/or trending cases that may have immediate and long term impact for members' compliance and regimen adherence by leveraging the redundant layers of protection built into the system and within the dynamic, trusted social network of caregiver support. The Health Service Management framework coupled with the physician integrated, member-centered health dashboards allow a 360 degree view of all member interactions in a fully transferable electronic health record.

Thus, the embodiments of a decentralized fusion engine used in member-activated continuity-of-care networks for health management disclosed herein provide an integrated, continuity of care network centered on the member and his/her caregiver team. Embodiments may provide a real-time, point-of-care compliance and adherence reporting solution, real-time point of consumption reporting mechanisms for medical supply chain optimization, and real-time pharmaceutical point-of-care/consumption efficacy reporting. Embodiments may provide an accessible, integrated, member-centered mobile health management network for at-risk populations, such as the chronically ill or demographically vulnerable. Embodiments may shift the delivery, consumption, and ownership of health management and outcomes from payer or provider networks toward a member-centered trusted caregiver teams.

The sweeping changes of the Healthcare Reform Act of 2010 were in response to perceived inefficiencies in the delivery and cost of health care in the United States. A focal point in the Healthcare Reform Act was the member—both member centered care and member activation in the ownership and management of health outcomes, especially member activation and ownership of health outcomes that have a direct correlation to overall therapy compliance and adherence. A central aspect of member activation and healthcare outcomes is the establishment of continuity of care networks outside the hospital setting and in the home.

The healthcare industry requires a paradigm where the trusted caregiver team becomes an intregal part of patient centered continuity care and is activated in support of the member to ensure member compliance and long-term adherence to the physician directed medical regimen. The system, computer-implemented methods, and computer-readable media described herein bridge the gap in continuity of care and coordination services within transitional and chronic care delivery mechanisms.

Member centered medical care empowered by activated, trusted caregiver teams of family and friends can improve member health outcomes while reducing redundancy and costs in existing member health interactions. Continuity of care and coordination of care is lacking in the present health care system. Including the member's family and friends as part of the extended caregiver practice in combination with caregiver-led virtual home monitoring can reduce hospital readmission, reduce the cost of delivery, and help avoid disease complications.

The participant members of a trusted caregiver team can share and operate in the decision input with the patient on a real time and/or on a asynchronous basis. This participation can fully engage a member of the network on a mobile device concurrent with the member's active participation in a separate mobile communications function with the information flow displayed on their smartphone or computing device. All of the above systems in each members cell are limited by the patient's encrypted privacy triage controls on information flows, subject to escalation events and medical directives that change in real time with the patients improvement or deterioration of medical condition. The resulting communication systems forms an integrated continuity of care network that drives all functions of health management and continuity of care horizontally across a trusted team network of caregivers and interdisciplinary healthcare professionals.

Integrated continuity of care networks for health management in non-institutional settings represent a shift in healthcare delivery and decision support by lowering the inherent economic, demographic, and social barriers associated with getting adequate access to healthcare services to at-risk populations including those who are chronically ill and/or demographically vulnerable.

A decentralized, member-activated continuity of care network, built on disease specific health service policies for resource participation, optimization and incident response is the convergence of mobile health services and mobile collaboration processes governed by an automated case management suite for member health management in non-institutional care settings.

Embodiments may provide one or more of the following integrated care components in support of continuity of care and coordination: member activated continuity of care network(s), provider customized/patient personalized health service policy templates, heath surveillance and decision support (e.g., including remote member monitoring, behavioral change communications, telemetry sensor normalization), remote command and control of member devices, health information curation, emergency supply chain optimization, and emergency response services. These combined features allow for automated behavioral change communications (“BCCs”) in response to health events and incidents. Customized decision parameters for BCCs may be set according to privacy standards, expertise, relationship levels, as well as other parameters. Thus, embodiments may enable real-time intervention by members of the network while a medical event or trend is in progress.

Embodiments described herein disclose a member-centered, network enabled (e.g., TCIP/IP enabled) continuity of care network (“CCN”) of computing devices and systems for communications and data sharing. CCNs enable people in a trusted caregiver team (“TCT”) to receive and send behavioral change communications (“BCCs”) in response to health events, incidents, trends and the like from the member. A member-centered CCN may be doctor initiated and payer approved. Once doctor-initiated and payer approved, the member may invite trusted family, friends, and other health advocates to join their TCT. One or more computing devices for each TCT member may then be joined into the member-centered, decentralized CCN. The member-centered, decentralized CCN may also include cloud services, provider services, and local services run on the member's computing device.

The member's CCN may be directed by a physician network and governed by a member-centered health services management (“HSM”) model. HSM may provide structure and controls to the CCN. For example, HSM may provide disease-specific protocols as templates with rules for escalation of health events, including providing BCCs to members of the member's TCT, automated requests for payer authorization for health regimen changes, and the like.

Thus, embodiments allow the member, rather than the practitioner or service provider, to share critical information (medical records, lab results, schedules/appointments, billing/insurance information, etc.) as well as communications (text messages, email, location based service, etc.) to caregivers (professional and personal) and/or experts or social medical networks to remotely manage therapy and/or medical regimens. This allows the member, versus the practitioner, to electronically control dissemination of information as well as guarantee member consent throughout the entire electronic “chain.”

A member-centered CCN (also referred to as member-activated collaborative care network) may refer to a methodology and integrated system to extend transitional care, disease management, and case management processes and resources beyond the institutional settings of hospital and clinics. A member's CCN may travel wherever the member goes—whether in the home, at the workplace, or on vacation. A CCN enabled by a decentralized, mobility-based client or fixed wire computing device may provide a continuous, virtual health concierge providing behavioral change communications, decision support and a life safety network for emergency services.

### (b) System Overview

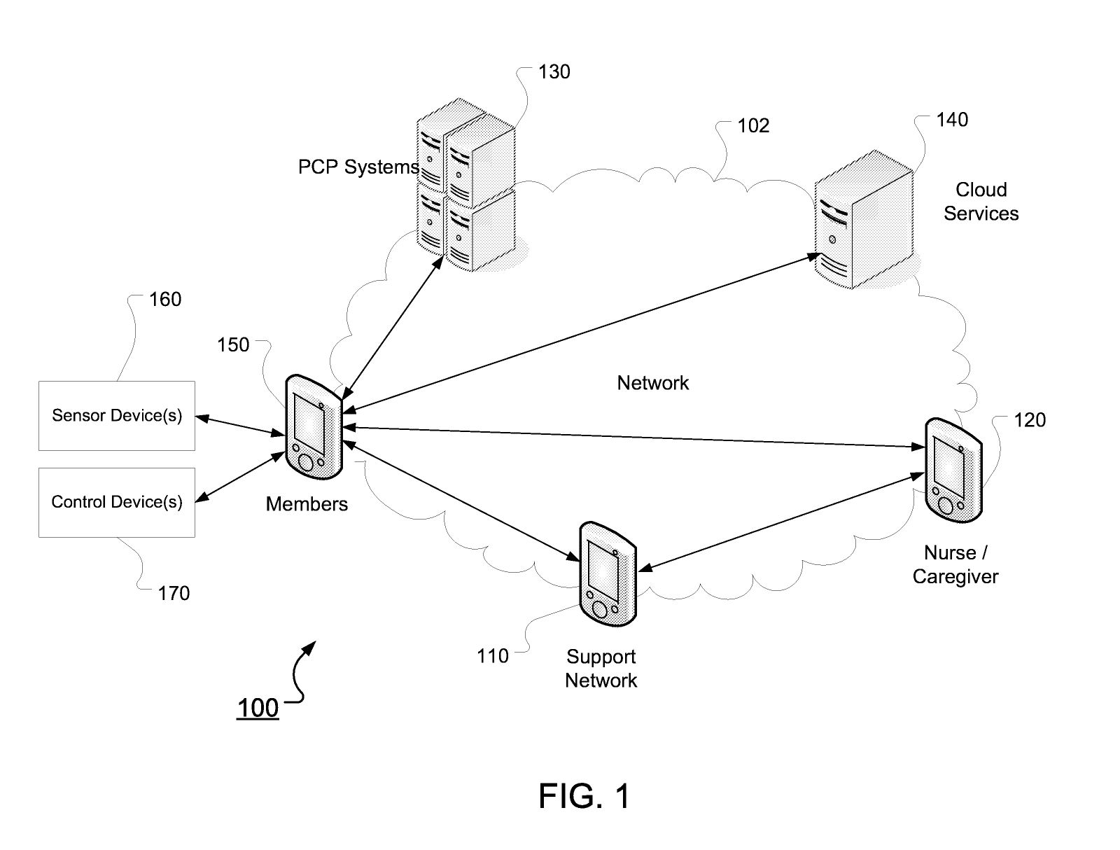

FIG. 1 shows an exemplary CCN 100. As shown in FIG. 1, the CNN 100 is decentralized with computing power, data capture and monitoring and other functionality distributed and available at each of the various components.

Each of these individual components and the features and functionalities of the CCN 100 will now be described. Members being managed typically interface with/connect to the CCN 100 with member devices 150. Member device 150 may be an edge-of-network computing device (e.g., a mobile device such as a smartphone) configured to monitor member data based upon a specified health service policy, for example monitor the member's biotelemetry, the member's location, and the like. It could also receive inputs from other devices such as sensors 160 or central devices 170. Member device 150 may transmit member data across one or more networks 102 to other devices and systems in the member's CCN 100, such as one or more TCT devices 110, a nurse or other caregiver device 120, one or more primary care provider (“PCP”) systems 130, and cloud services systems 140. Of course, CCN 100 may include any number of additional devices and systems or may omit one or more devices or systems shown in FIG. 1.

TCT devices 110 may be used by trusted family, friends, and other caregivers of a member to assist with daily therapy compliance, program adherence, health management, and the like. CCN 100 may include multiple TCT devices 110 coupled to (i.e., in communication with) a member device 150, thereby providing a few-to-one or many-to-one support network for the member. For example, a CCN for a young member may include TCT devices 110 for the member's father, mother, and a friend of the family. By including plural people's devices with customized privacy and intervention alert levels within a CCN, the responsibility of monitoring member data may be distributed amongst the TCT. Additionally, such a group may provide monitoring redundancy, for example if the member's father has to fly on a plane that does not provide internet access, others in the member's support network may monitor member data until the father's device again has access to the CCN.

A member's CCN 100 may be dynamic, expanding and contracting in response to a member's needs, schedule, and the like. For example, CCN 100 may also include a nurse/caregiver device 120 for a school nurse that school nurse may be in the best position to respond to a member's health emergency during school hours. However, CCN 100 may include a role based access control (“RBAC”) framework to limit the access rights of nurse/caregiver device 120 to only receive telemetry and location data for the member during school hours.

Support network devices 110 and nurse/caregiver device 120 may be mobile computing devices, such as smartphones, thereby enabling the member's CCN 100 to monitor data received from member device 150 at substantially all times. TCT devices 110 and nurse/caregiver device 120 may receive substantially real-time health data from member device 150 to allow the TCT to allow for an effective intervention mechanism if necessary and immediate support should the member experience a medical emergency.

CCN 100 may also include one or more PCP systems 130. PCP systems 130 periodically receive member data from member device 150, for example substantially real-time member data, periodic or aperiodic member data reports, trending data, and the like. PCPs or other medical practitioners may utilize PCP systems 130 to diagnose members, monitor effectiveness of therapy regimens, and the like. CCN 100 may allow a PCP or medical practitioner to monitor and diagnose plural members while leaving a TCT of family, friends, nurses, and the like to monitor the member's therapy regimen compliance, potential emergency situations, and the like.

CCN 100 may include or access cloud resources 140. Cloud resources 140 may provide a broad range of services, including using autonomous agents (for example, bots) for monitoring member data received from member device 150 and, at times, responding to member data by sending a message or control signal to member device 150 or contacting escalation services (e.g., “911”) according to rules defined by the applicable health service policy. Autonomous agents may provide continuous (i.e., 24/7) monitoring and may trigger appropriate responses in response to any type of event (these responses could include providing a message to a member in response to a missed dose, contacting members of the trusted care network in response to a trending health incident, or contacting emergency services in the event of a detected emergency, for example). Cloud resources 140 may also include dynamic resource registries, health service policies, monitoring services, data analytics, on-boarding and member activation services, and the like. Details of the cloud resources 140 are disclosed in greater detail below.

A member device 150 may also health service policy logic and algorithms configured to monitor continuously the member health events. In similar fashion to the cloud services bot described above, local health service policy logic may trigger appropriate responses to any type of event. Additionally, the local health service policy logic may be configured to maintain conformance with the applicable health service policy template in the case that a member device 150 loses all network connectivity for a period of time. In other words, if a member device 150 goes off-line, the local health service policy logic may detect member events and escalate the events according to the specific member health service policy template so that when the member device 150 comes back on-line (i.e., connects to a communication network), the member device 150 may immediately take the necessary steps to respond to the member event (e.g., escalate the event to the appropriate degree or, if the event as been resolved, appropriately document the event).

CCN 100 illustrates a functional and communication relationship between plural computing devices. However, each computing device's configurations may be governed by a member-centered Health Service Policy templates discussed below. The member-centric Health Service Policy template provides a functional hierarchy and structure to the relationship of the computing devices making up CCN 100, including providing escalation and intervention services and payer approval/preapproval services.

The devices and systems comprising CCN 100 may be operatively coupled by one or more networks 102. Network 102 may include one or more of the internet, local area networks (“LANs”), wide area networks (“WANs”), mobile telecommunications networks (e.g., 3G and 4G networks), and the like.

### (c) Decentralized Network

As illustrated in FIG. 1, a CCN 100 includes one or more decentralized computing/communication devices (110, 120, 130, 140, 150) configured to communicate with one or more other computing device. For example, each of a plurality of computing devices may utilize mobile health client software executed on a computing device utilizing a decentralized data fusion engine for decision support networks, for example as provided by Blueforce Development Corporation. Unlike conventional mHealth systems, embodiments may capture and store member data in a distributed fashion, for example, on the member's computing device, rather than storing and accessing data on a central server or plurality of distributed servers.

Each communication device (110, 120, 150) in the decentralized network 102 may originate communications to any other communication device in the decentralized network. Thus, the decentralized network may allow for scaling of compliance and intervention tasks. For example, upon detection on a member's device 150 of a compliance event, the member device 150 may determine if the detected compliance event should be escalated to an incident that one or more members of the member's trusted caregiver team (TCT) should be notified of. If the member's device determines that one or more members of the TCT should be notified, the member's device may use functionality supported by the fusion engine to transmit a behavioral change communication or BCC (e.g., a notification, alert, etc.) directly to the devices of one or more members of the TCT. The distributed component of the fusion engine together with other mobile health client software on each TCT member's device 150 can then receive the notice, provide a user interface alert (e.g., a screen, sound, etc.) to the TCT member, and allow the TCT member to send a message back to the member from whom the BCC originated.

Thus, embodiments may allow for a direct one-to-many communication notifying TCT members of a compliance event. This facilitates providing a human network to support, motivate, and care for the member. The embodiments also allow for many-to-one communications, for example, from TCT members to patient/member. Additionally, by allowing for direct transmissions, embodiments may avoid potential loss of service issues that centralized services may be affected by.

Embodiments may also provide for direct communication between the member's communication device 150 and intervention services if the member's communication device determines that escalation beyond the TCT support network is necessary. For example, the member's device 150 may communicate directly with emergency services (e.g., 911), the member's primary care provider (e.g., if a change in dosage appears necessary), or the like. The member's device 150 may also communicate with cloud services or directly with a payer system to request payer authorization for a health regimen change. If granted, payer authorization may be bundled for electronic data exchange (“EDI”) and transmitted directly from the payer to a service provider.

In addition to the client side solutions for the member and his/her network of trusted caregivers, the system employs a decentralized member network operations console (pNOC, not shown in FIG. 1) for the health professional as well as for the non-professional responsible for managing multiple members. The pNOC dashboard is dynamic and driven by functional role, permissions and availability of resource enabling real-time monitoring, intervention, and mobilization of resources in response to any health event/escalation. The pNOC functionality enables a healthcare professional (physician, nurse, nurse practitioner, nutritionist, an allied health professional, and/or a health coach) to have a personalized dashboard specific to their role and expertise so they may provide continuity of care services concurrently to a number of members each with their own discrete, individually tailored physician directed parameters of therapeutic care. Exemplary user interfaces for pNOCs will be described later.

### (d) Fusion Engine

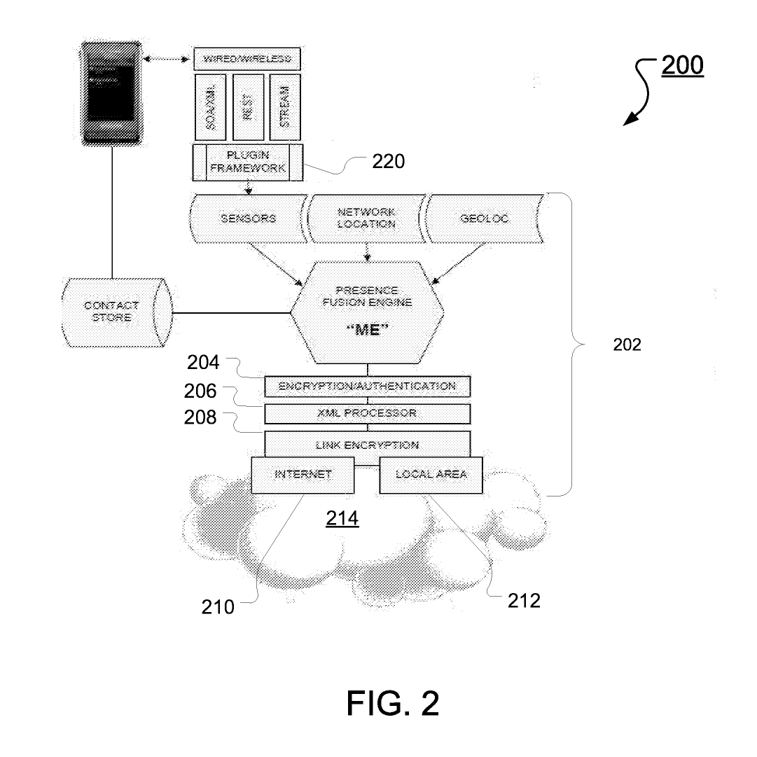

FIG. 2 is a functional diagram of an exemplary fusion engine provided by Blueforce Development Corporation that may be implemented to provide the above described decentralized network and data transfer capabilities. The fusion engine is disclosed in U.S. provisional patent application 61/421,880, the contents of which are hereby incorporated by reference. The fusion engine is also described in Blueforce Development Corporation's published PCT application WO 2012/078983.

As illustrated, when the fusion engine 200 is implemented, it provides a presence fusion engine 202, which: is primary fusion bus; fuses location and sensors attached to the endpoint; encodes and decodes for transport to subscribed entities; expands and contracts; supports 1:N sensors. As shown, functions such as encryption and authentication 204, and XML processor 206, link encryption 208, and access to the internet 210 and a Local Area Network 212 can be server-based or cloud-based 214. At the client side, the engine provides a plug-in framework 220 with a bi-directional interface and support for one or more sensors. A “contact store” 230 is also shown. It stores information about endpoints to which each user subscribes to. Endpoints can be people, devices, or processes.

The fusion engine enables the following functionality which may be utilized by embodiments disclosed herein: a dynamic (expandable/collapsible) presence protocol for data fusion (i.e., incorporation of all data into a data stream for bi-directional communication between devices); architecture for sensors and backend data sources; a bifurcated application layer access control framework for role based access and privileges; and a bidirectional command and control stack and interface.

Embodiments may allow the member's computing device to receive various telemetry/biotelemetry data from sensors attached to or near the member. The member's computing device may receive data in real-time, near real-time, periodically, or aperiodically when a sensor reading or measured trend passes a threshold, etc. Embodiments may likewise use the framework to transmit communications to devices. The framework may also be used to securely transmit a dynamic fusion data stream (e.g., including combined presence data, BCCs, and other data) across non-secure networks.

Embodiments may utilize standard (e.g., cross-platform (e.g., iOS, Android, BlackBerry OS, Windows Phone 7, etc.)) plug-ins to interact with devices. In this way sensor and control device manufacturers can rapidly build plug-ins to securely share information with the fusion engine. Additionally, embodiments may be deployed using existing or to-be-developed computing systems and communication platforms.

The fusion engine can allow a member to configure his/her device to communicate with other devices (e.g., sensors 160 or control devices 170 shown in FIG. 1) by selecting such other device from a list on a user interface. The fusion engine then utilizes an appropriate plug-in. Alternatively, embodiments can automatically mate with the device, such as via Bluetooth. In other embodiments, in the doctor onboarding process, a doctor may identify one or more devices to be mated to the client's computing device and the appropriate drivers can then be pushed automatically to the client's computing device.

### (e) Services Provided by CCN

The above described CCN in FIG. 1 provides secure fusion data communications between a decentralized network of computing devices. Secure, bi-directional fusion data from each device may include location based services (“LBS”), presence protocol data; command and control data; among other data and services. The following describes exemplary elements of the fusion data communications in greater detail.

The member-centered CCN allows for bidirectional communication between the systems and devices. In addition to a member device transmitting member data to other devices and systems, other devices and systems may transmit messages, control signals, and the like to a member device or to other devices and systems in a CCN. Transmissions may be directed to a specific device or system or may be broadcast or multicast to all or a subset of all devices or systems in a CCN. Transmissions may be encrypted and, thus, may securely travel across public networks, such as the internet and wireless networks.

For example, a member device may include a user interface configured to prompt the member when they should take a prescribed medication dose and, in response, receive an indication from the member whether or not they took the medication dose. Prescription compliance data may be included in member health data that member device transmits to devices and systems in a CCN. When an interface of a TCT device shows that the member has skipped a prescription dose, a family member or friend may use a support network device to send a message to the member device regarding the skipped dose. Messages may be sent, for example, via a secure data connection and appear within an application running on member device, via a xml message service, Short Message Service (“SMS”, i.e. “text”) message, via a voice phone call, email, and the like. A device in the CCN may also send a message to one or more other devices in the CCN, for example a user of a TCT device that notices a skipped dose may transmit a message to a nurse device for a school nurse if the member is at school to prompt the nurse to follow up regarding the member's missed dose.

Of course, a member of the member's support network may also reach out to the member in any other fashion after they are notified regarding a health event or incident. For example, a member's family member or friend may call the member or physically go to the member's house to check on the member. Because the support network may be comprised of a few people who are trusted by the member and who have a personal interest in the member's health, the members of the support network may have both greater access to the member and a greater interest in influencing the member's behavior in a healthy way than those traditionally involved in member care (e.g., service providers, insurers, doctors, and the like).

(i) Location Based Services

Embodiments may be configured to provide location-based services (“LBS”). LBS may utilize the ability to determine the geographical position of the member's mobile device 150 and may transmit the member's device location to one or more support networks 110. Members of the member's trusted support network may use LBS to visit and support the member. Additionally, LBS may be leveraged for cloud services, for example to determine which provider resources (e.g., doctors, etc.) in network are within five miles proximity of the member. By way of further example, LBS may also be used for content curation discussed below, for example to invite the member to an event if the member is determined to be in a location proximate the event.

(ii) Presence Protocol

Embodiments may also be configured to provide one or more CCN devices with presence information. In computer and telecommunications networks, presence information is a status indicator that conveys ability and willingness of a potential communication partner—for example the member—to communicate. A member's client device may provide presence information (i.e., presence state) via a network connection protocol to a presence service (e.g., as part of cloud services), which is stored in what constitutes the member's personal availability record and can be made available for distribution to CCN devices to convey availability for communication. Presence becomes interesting for communication systems when it spans a number of different communication channels. The idea that multiple communication devices can combine states, to provide an aggregated view of a user's presence has been termed Multiple Points of Presence (“MPOP”). Embodiments provide one or more TCT members with presence information of one or more other members of the TCT. This may allow the TCT members to make sure at least one member is capable of monitoring member events.

(iii) Command and Control

A CCN may also allow a member device to receive control signals transmitted by one or more systems or devices in the network. These signals and other data can be transmitted to and/or written to the member device for later read-access. In this fashion, remote systems and devices in a CCN may control devices operatively coupled to member device. For example, cloud services may include an autonomous agent configured to monitor member data and, if an aspect of member data reaches a threshold value, transmit a signal to member device to perform a task. For example, a diabetic member may have both a continuous blood glucose monitor (“CGM”) as a sensor device that transmits periodic blood glucose level readings to the operatively coupled (e.g., wirelessly) member device. The member may also have an insulin pump control device also operatively coupled (e.g., wirelessly) to the member device and configured to receive control signals from the client device. As the client device receives glucose level readings, it may transmit or broadcast the readings to one or more devices or systems in the CCN. The autonomous agent may substantially continuously observe the blood glucose level readings and transmit a message or control signal if the member's blood glucose level goes above or below a threshold value, deviates outside a threshold range, trends in a dangerous direction, and the like. For example, if the autonomous agent detects that the member's blood glucose level drops below a first threshold value, the autonomous agent may transmit a signal to the member device to reduce the insulin dosage of the insulin pump control device.

In addition, the member device may include one or more internal accelerometer or may be operatively coupled to one or more accelerometer sensor device and the member device transmissions may include acceleration data. In such embodiments, autonomous agent may monitor a member's acceleration in addition to the member's blood glucose level. The autonomous agent may be configured to send a signal to a member device to suspend insulin dosage if the accelerometer data indicates that the member is no longer moving and the CGM data indicates the member's blood glucose level has dropped below another threshold value.

Of course, the above discussed sensor devices and control device are exemplary only. Embodiments may be configured to operatively couple with any sensor devices, control devices, or combined sensor and control devices. Additionally, embodiments may operatively couple to one or more intermediate devices to enable convenient coupling to one or more sensor or control devices.

The fusion engine illustrated in FIG. 2 may provide LBS based on global positioning system (“GPS”) data. The fusion engine may also provide LBS based on a determined proximity to other devices that emit a signal. For example, member's location data may be derived from network data from beacons in subway tunnels.

The fusion engine in may also be useful for monitoring the health of the various sensors and the system itself. For example, the member's computing device may monitor sensors and control devices attached to the member and notify cloud services if there is an anomalous event, failure, or the like.

The fusion engine may also be useful for monitoring motion and tilt. This may be useful, for example, embodiments to recognize an emergency if a member is no longer moving, if a member suddenly falls, and the like. Motion and tilt may additionally be used in combination with member biotelemetry data to recognize and respond to emergency situations. Motion and tilt may be detected, for example, by an accelerometer and three-axis gyroscope having an extensible interface and Bluetooth interface provided by Shimmer.

The fusion engine may combine data into a heartbeat data stream that may be expanded or contrasted based on the amount of data for a given person, such as the amount of data authorized to transmit or amount of sensors currently providing data to the member's device.

### (f) CCN Operations

(i) Physician Directed Onboarding

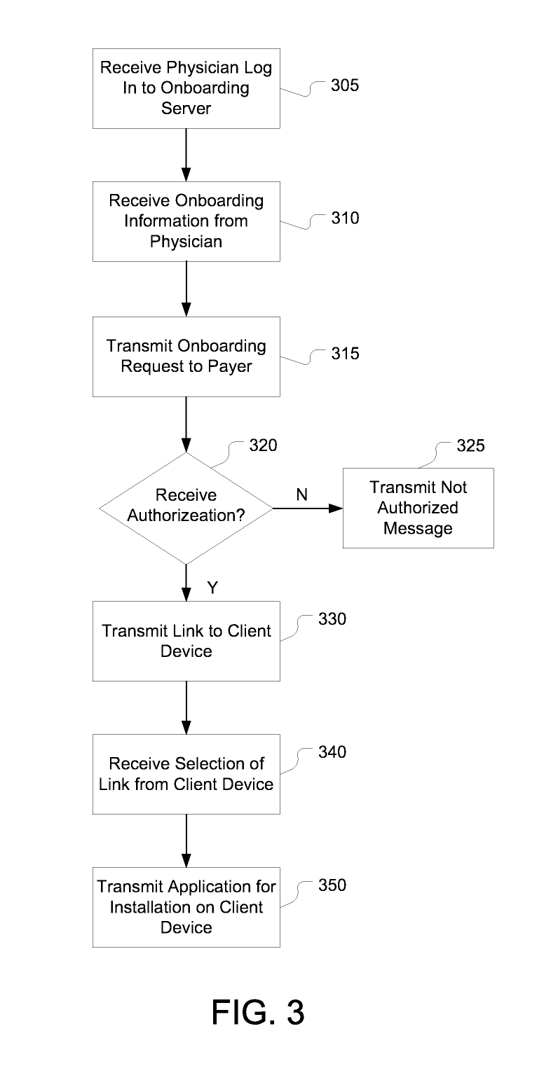

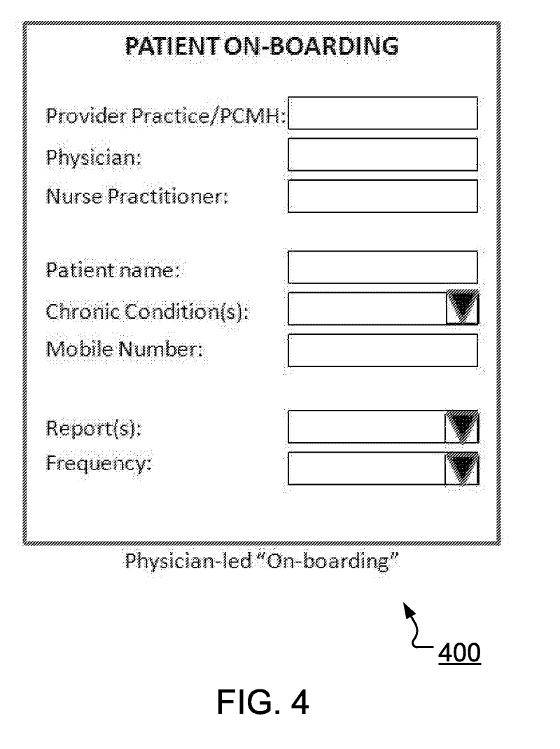

Initial onboarding of a member into a mobile health system may be directed by the member's physician. FIG. 3 shows an exemplary process flow for a member's physician to onboard a member into a CCN, such as the CCN discussed in relation to FIG. 1 above. At step 305, an onboarding server (e.g., hosted as part of cloud resources 140 shown in FIG. 1 or hosted by one or more other computing devices operatively coupled to network 102 of FIG. 1) may receive login credentials from a physician. For example, a physician may login to the onboarding server through a web interface provided by an internet browser. Once a physician is logged in, the onboarding server may transmit a user interface for the practitioner to enter member onboarding information. For example, FIG. 4 shows an exemplary member onboarding interface 400 in which a physician may enter information for member onboarding. Of course, interface 400 is exemplary only and alternative or additional interfaces may be presented to a physician to enter client information. Once the physician enters member onboarding information, the onboarding server may receive onboarding information from the physician at step 310.

At step 315 the onboarding server may then transmit an onboarding request to a payer for the member. For example, in countries having private healthcare systems, an onboarding request may be transmitted to a private insurance company's systems requesting authorization to onboard a member. The onboarding request may include information such as member identifying information, chronic conditions to be monitored, a cost to the payer for onboarding the member, and the like. Alternatively, if a member will pay directly, the request to payer may be a message sent to the member requesting a payment method. In still other embodiments, the process flow may proceed from step 310 directly to step 330 discussed below without requiring payer authorization.

In response to the request, at step 320 the onboarding server may receive an indication whether the request is authorized or not, for example from a payer. If the request is not authorized, at step 325 the onboarding server may transmit a message to the physician and/or the member indicating that the member will not be onboarded. The process flow may terminate at this point, the physician may enter a new onboarding request, or any other steps may be taken. Alternatively, if the request is authorized, at step 330 the onboarding server may transmit a link to the client device, for example in an SMS message, email, or other digital communication.

A member's device may then receive the link and the member may select the link to install the application. In response to the member's selection, the onboarding server may receive the selection at step 340 and transmit the application for installation on the device at step 350.

By providing functionality for physician directed onboarding, embodiments may integrate physicians within the member's personal CCN. This enables a physician who has personal knowledge of and a close relationship with a member to be directly involved in the member's condition monitoring and general health monitoring. In contrast, conventional mHealth systems generally tend to utilize their own subject matter experts to disintermediate the member's physician from the member's care and health monitoring.

Of course, various steps in the onboarding process may be combined and the steps may be subdivided into further steps. Additionally, the onboarding process may provide further functionalities. For example, the application transmitted to the client device at step 350 may be a member specific application having interfaces related to the chronic condition(s) designated by the physician during the onboarding process. Alternatively, a general application may be transmitted and a parameter or template may be provided designating relevant screens to employ for the member and/or relevant trending scales or alert data points endorsed by medical experts, societies, member groups, or other sources.

By way of alternative example, the application may provide one or more plug-ins to facilitate communication between the application and various sensors and/or devices operatively coupled to the member's computing device (e.g., a CGM, insulin pump, scale, accelerometer, ECG, etc.).

(ii) Member Onboarding

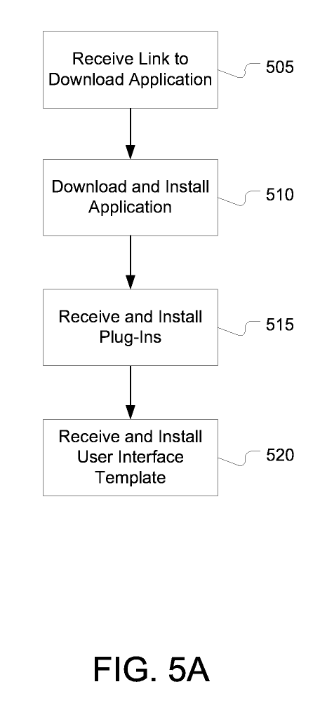

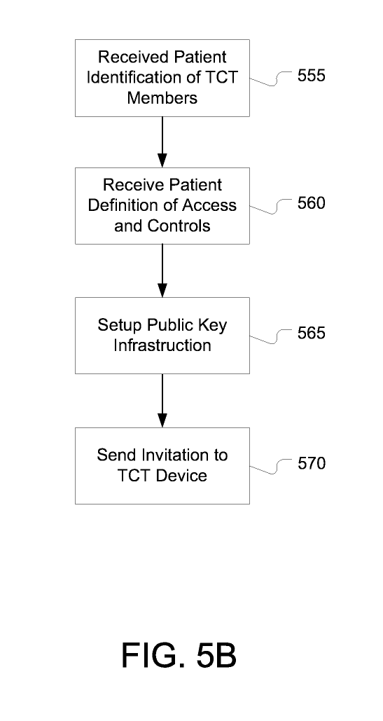

FIG. 5A illustrates an exemplary process flow for onboarding. At step 505, the member's device (e.g., a mobile phone) may receive a link to download an application, for example in a SMS message. At step 510, the member may select link to cause their mobile device to download and install the application. At step 515, the device may also receive and install plugins to facilitate communication with other devices (e.g., sensors, meters, therapeutic devices, etc.) operatively coupled to the member's mobile device. At step 520, the device may receive and install a user interface template, for example specifying screens relevant to one or chronic condition specified by the physician during the physician onboarding process shown in FIG. 3.

(iii) Trusted Caregiver Activation

Activation of the trusted caregiver team for continuity of care and health collaboration may refer to the explicit consent granted by the member to instantiate his/her TCT members. To instantiate, the participant may designate a parent/child relationship for the caregiver “affiliate member” via a role based access control (“RBAC”) framework. The instantiation may be managed through a public/private key exchange (“PKI”) that provides end-to-end encryption, local data security, as well as access privilege designation for the affiliate members.

FIG. 5B illustrates an exemplary process flow for member activation of TCT members. At step 555, the device may receive the identification of one or more people or identifiers of one or more devices corresponding to one or more people (e.g., via phone numbers, IP addresses, etc.) the member wishes to add to their TCT. For example, a member may provide phone numbers for their parents and a friend who they wish to add to their support network. At step 560, the device may receive the member's definition of access and controls for the TCT member. For example, a member may limit a nurse's access to their telemetry or location data to school hours but the same member may allow their wife to have full or nearly full access and control. At step 565, the device may setup a public key infrastructure to allow for secure data transmission between the member's device and the device of a TCT member. Finally at step 570 the member's device may send an invitation to the new TCT member's device. For example, this may cause a text message to be sent to a provided phone number including a link to securely download an application to enable the TCT member's device to join the member's CCN.

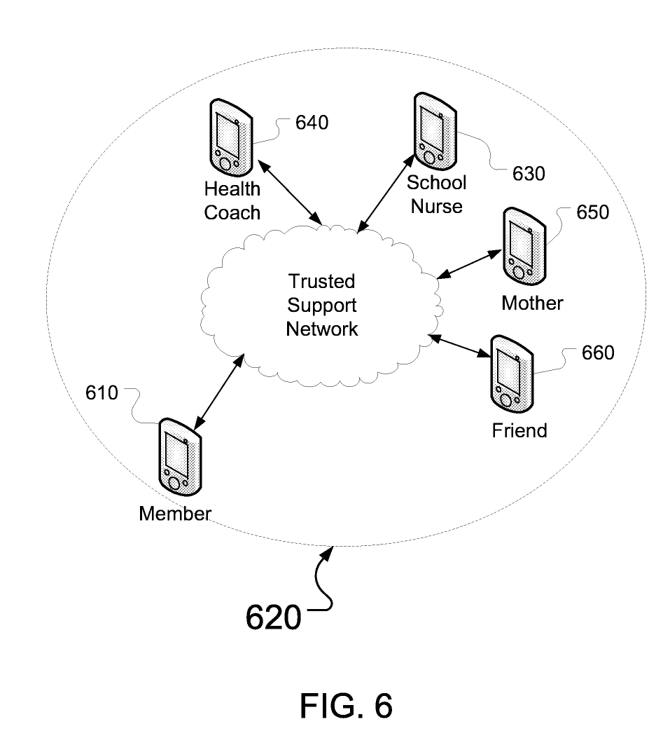

For each person the member adds to their support network, the member may specifically indicate the level of access (i.e., RBAC) that the TCT member has. FIG. 6 shows an exemplary trusted caregiver team 620 including devices for TCT members. While any number of individuals may be included in a member's trusted support network, in many instances a handful of trusted individuals who are particularly able to assist the member with meeting their goals may be selected. Exemplary trusted support network includes a device for the member's mother 650, friend 660, school nurse 630, and a health coach 640. Each of these members of the TCT may have different roles in the support group and different access rights defined by the member 610.

For example, the mother 650 may have access to biotelemetry data, location information, goals, and milestones for the member to allow the mother to monitor the member's health, location, progress toward goals and milestones met. In contrast, a friend 660 may receive only goals and milestones information so that the friend can provide support and generally assist the member to live a healthy life while allowing the member to keep their health and location information private. A school nurse 630 may receive access to much of the member's data, for example biotelemetry data, location, and the like, however the nurse's access may be limited to only between the hours of 8:00 am and 4:00 pm on weekdays during the school year. A health coach 640 may additionally be given access to various data points as desired by the member 610. Of course, the data provided by embodiments may be divided in greater detail and may be provided to many more individuals or systems as desired by a member.

Embodiments may also allow a member to designate authority to one or more people in their TCTN to add others to the TCT. For example, a member may allow their mother to add others to their TCT, but may limit such a right so that the mother can only allow others to see the member's milestones. In this fashion, the member may receive support from a broader network when milestones are met, thereby assisting the member to live a healthy lifestyle, while preserving the member's privacy to a great extent.

In other embodiments, a member of the member's TCT may have greater rights than the member for controlling access rights to the member's TCT. For example, a five-year-old member's mother may have full access to determine who can join her child's TCT and each member's respective access rights.

The member's TCT may also include an automated platform for escalation of events for life safety or precipitating negative trend events or data. An automated “bot” infrastructure may be delivered as a cloud service, enabled by algorithm and business logic, to intervene when all other members of the trusted caregiver (member affiliate members) are not online.

As shown, embodiments may provide for direct communication between TCT members. For example, the devices may securely create a VPN across a mobile carrier's network, thereby providing secure communication with no application services having access to transmitted data.

### (g) Health Service Management

Health Service Management (“HSM”) is a framework methodology for developing, managing and measuring continuity of care on both a medical protocol as well as service delivery basis. In other words, HSM is a set of management software processes executed by one or more computing device and methods to manage continuity of care in non-institutional settings (e.g., home, work, etc.) via a health service-centered approach. Disclosed HSM technologies help provider, member, and payer networks view and manage continuity of care activities (e.g., transitional, chronic, and palliative) to better support and maintain the positive health outcomes of the member.

HSM allows member centered health teams, including Accountable Care Organizations, Primary Care Providers, Local Community Services, Member-centered family Caregivers, etc., to operate by service rather than by individual function, enabling prioritization of efforts, with the aim of improving the service that is delivered to the member end user. A Health Service Policy (for example, a Patient-Centric, Diabetes Care Plan) is directed by physicians, activated by patients, supported by trusted caregivers, and ultimately monitored by insurers.

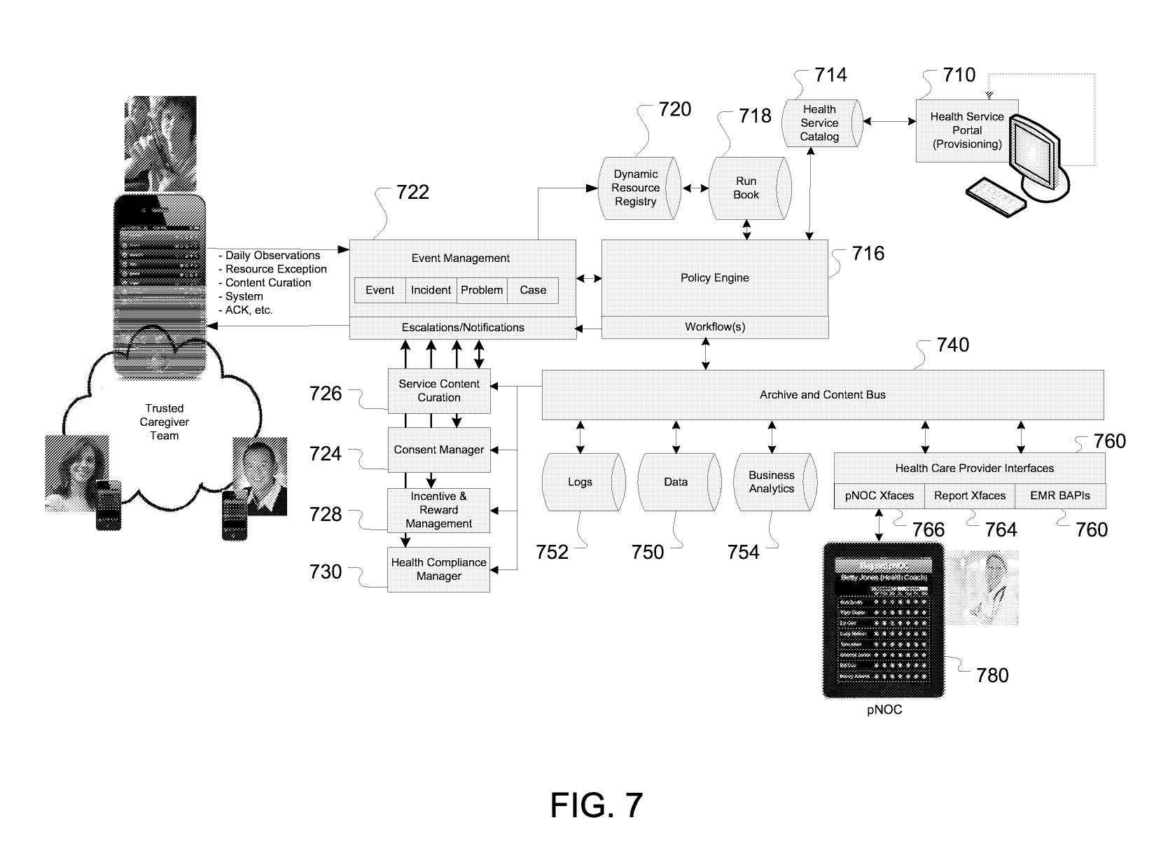

FIG. 7 is an overview of an exemplary system for implementing a Health Service Management framework. As can be seen, its major components include a Health Service Portal 710 for provisioning, a Health Service Catalogue 714 for a directory of available disease service templates, a Policy Engine 716, a “Run Book” 718, a Dynamic Resource Registry 720, an Event Management Module 722, a Consent Manager 724, a module for Service Content Curation 726, a module for Incentives and Reward Management 728, a Health Compliance Manager Module 730, and an Archive and Content Bus 740, all of which allow service to be provided/content to be delivered to/via the pNOC device 780. Each of these components will be described in greater detail below:

(i) Health Service Catalog 714

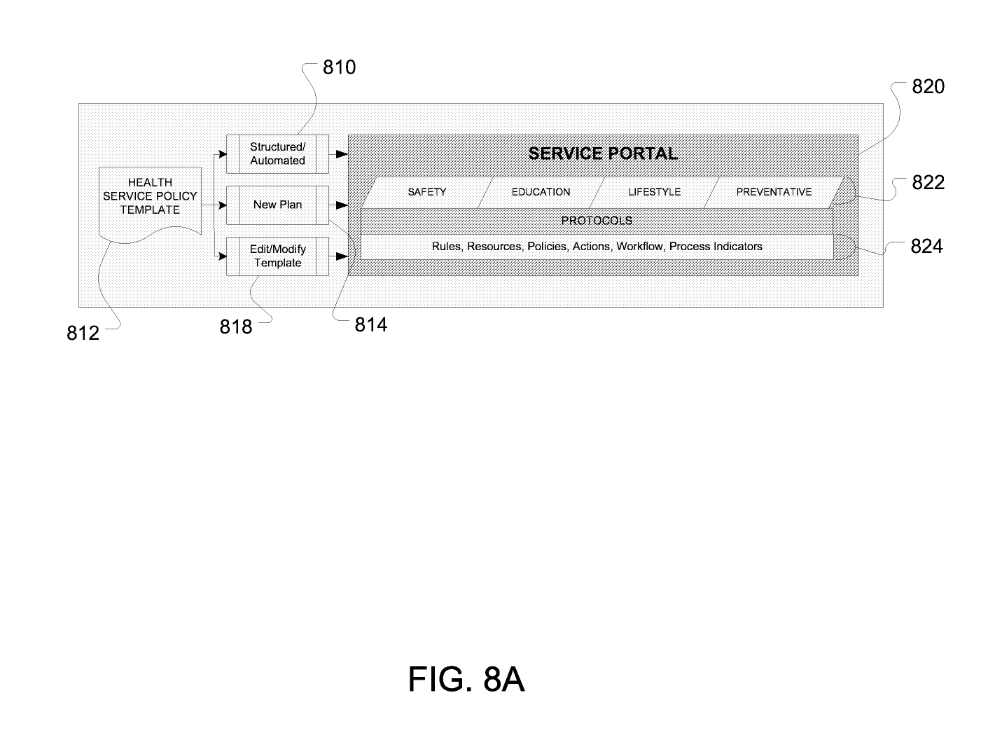

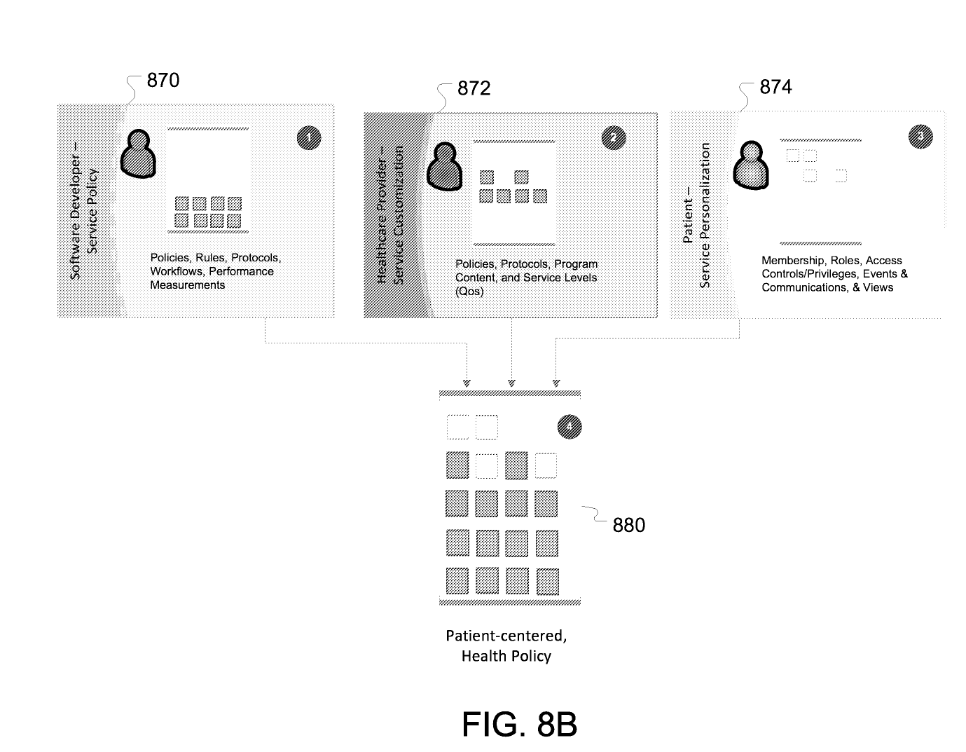

The Health Service Management (HSM) framework provides business logic enabling a Health Service Catalog 714. Built on a similar model for delivering IT services, the Health Service Catalog 714 is a certified registry of “released and/or available” health service protocols organized as templates [Health Service Policy Templates, see FIG. 8A] of individual or as comprehensive sets of services that a healthcare organization provides to its members under managed care or otherwise. Each Health Service Policy template within the catalog typically includes:

A description of the health service protocols

Quality of Health Service measurements

Individuals able to view/request/modify/the health service template

Costs for Health Service

Details as to fulfillment & reporting mechanisms for the Health Service offering

The use of a Health Service Catalog 714 for health management and transitions-in-care is a useful part of member-centered, integrated continuity of care. Members of a caregiver team would use the Health Service Catalog 714 to view pre-templated protocols and/or discrete add-on services allowing for adaptive prescriptive services based upon health conditions and/or desired health outcomes. Furthermore, given that many members have more than one condition, the Catalog allows for the selection of multiple conditions and this identifies overlap in the treatment protocols. It also serves to flag potential contraindications when overlapping therapies create the potential for adverse affects. Members and caregivers would also see the different service level options based on resources, availability and location of services and service providers. With this knowledge, members and their caregiver team are able to change the configuration of the health protocols services (i.e. standard, premium, etc.) used to manage the services based on cost, performance and resource availability.

Thus, accessed through a self-service, health-service portal, the Health Service Catalog 714 maintains a list of available health services that have been “practitioner/provider” approved from which members, providers and/or trusted caregivers select for self-provisioning and activation. The Health Service Protocols and Definitions are preferably standardized in the health service catalog. This presents three benefits: quick health service provisioning to the member and caregiver team, improved healthcare capacity and resource planning, and better predictive forecasting relative to member compliance and long-term adherence to specific health care plan.

(ii) Health Service Policies

The Health Service Management (HSM) framework enables healthcare providers to create, customize, and manage Health Service Policies for using or relying on the Policy Engine 716. Upon selection of a specific set of “Services” from the Health Service Catalog 714, a Service Policy is to define a stated course of care for the member by structuring the discrete protocols (Lifestyle, Vitals, Treatment, Safety, Education, other), events, rules, resources, and workflows for a specific health condition.

The Health Service Policy template is stored in the Health Service Catalog 714 and may be reused as-is, or modified so as to “fine tune” for a specific member or groups of members that require modifications to the “current best approach”, or, where a baseline template may be used with the need for discrete add-on services as offered in the Health Service Catalog. The Health Service Policy template is used to seed parameters inside of HSM cloud services and is core to the dynamic definition of workflows, notifications, and escalation.

As shown in FIG. 8, Health Service Policies may be introduced into the HSM cloud via three primary interfaces:
1. Structured/Automated 810: Here the HSM will expose a standards-based interface for automated creation of Health Service Policy Templates 812. This interface will be exposed such that others, such as system operators and/or health care providers, may create interfaces to proprietary data pumps such that health care providers may use a legacy Electronic Medical Record (EMR) system to introduce Care Plans into Health Service Policies.
2. New Plan(s) 814: HSM will expose a multi-step process via a “Portal” that will allow a health care practitioner to enter Care Plan(s) manually and save as a health policy template which may be used specific to a health condition or disease state.
3. Edit/Modify Policy Template 818: Here the HSM will allow for the health practitioner to “clone” an existing policy template for modification and then save as a unique, personalize service template. This template will also allow the healthcare practitioner to modify and then store the original health policy. The latter is more of an interface to allow for innovation of approaches specific to a health condition or disease state.

Upon creation of a new Health Service Policy, it becomes available as a template for members and/or provider network. Upon editing a policy, the template reseeds the appropriate HSM cloud subsystems and is pushed to members who must acknowledge receipt and acceptance of the updated service using the Consent Manager 724 protocol. This process and the customization of a template are illustrated in FIG. 8B. As shown in this figure, in step 870 a software developer defines, engineers and develops policy-based, health service templates for disease management and compliance. Then, as shown in step 872, the healthcare provider modifies and extends health policy based upon internal protocols, best practices and privacy/security measures. Thereafter, at step 874, the patient personalizes his/her specific health policy template by controlling membership, access controls and privileges as well as events and communications. Finally, the resultant, shown at step 880, is a patient-centered, provider-directed health policy solution for disease management and compliance.

The Health Service Policy object model is comprised of protocols and component objects that are created using any of the above referenced input interfaces. The protocols are exposed as discrete collection screens as part of the Health Service Portal 820 and in context to various prescriptive actions or indicators which include, but are not limited to: Lifestyle, Vitals, Treatment, Safety, Education, etc. Each protocol of a Health Policy (e.g., Education for Diabetes) is comprised of six core business objects 824:
1. Rules: Rules define the parameters specific to the above referenced actions and/or indicators. Rules are defined using operators that include; equal to, greater to, less than, or “in this range.” Rules are written to the “Run Book” 718 which is then made available to multiple HSM subsystems.
2. Resources are of devices that are prescriptive or desired as part of the health regimen. Rules may be built around these resources and used as another correlation and/or test parameter for events, correlation, and/or escalation. Resources are written to the Dynamic Resource Registry which is then made available to multiple HSM subsystems.
3. Policies: Policies enforce “Rules” and are activated as the result of a Rule(s) violation. Policies are written to the Rule Book which is then made available to multiple HSM subsystems.
4. Actions: Actions define system, member, caregiver, and process instructions when rules and policies are exceeded or are out of range. Actions prescribe “which” workflow as well as predefined correlation and escalation. Actions are also written to the “Rule Book” which is then made available to multiple HSM subsystems 5. Workflows: Workflows fire events which cause predetermined actions to execute. Workflows remain active until all events are closed. Workflows are also written to the “Rule Book” which is then made available to multiple HSM subsystems
6. Process Indicators: Process Indicators are the prescriptive measurements (surrogate markers) that define fulfillment of service as well as quality of service (QoS)

Returning now to FIG. 7, it can be seen that upon selection of a Template 812 or other set of services from the Catalog 714, HSM correlates the selected set of services with the specific member. Associated rules, resources, policies, and workflows are then stored and called from the “Run Book” 718. Required resources are also stored in the Dynamic Resource Registry 720 such that system resources may be allocated dynamically based on user community needs.

The Run Book 718 is referenced by the Policy Engine 716 when events are received by HSM from a specific member and/or his/her trusted caregiver network. While “Rules” are treated as largely parameter-based functions, the Policy Engine 716 constantly evaluates incoming events as member state evolves over time.

The Policy Engine 716 stores policies, each associated with one or more Care Plans. Policies enforce “Rules” and are activated as the result of a Rule(s) violation. A value is passed from the Event to the Policy Engine 716 which then tests against stored Policies. Examples of a policy include:
Frequency of evaluation: Health Service protocol stipulates testing of glucose levels 5 times a day. Policy violation would flag “true” if glucose testing only came in from a specific member at 4 times on a given day. If Policy Violation flags “true”, fire an event.
Associated workflow: Should the Event test “true” when applied against a discrete (or multiple) policy(s), a Policy declared workflow is set in motion.

The Policy Engine 716 also correlates resource allocation based on rules, needs, and requirements as stored in the Dynamic Resource Registry.

When events cause Policy violations, the Policy Engine 716 initiates workflows and System Events that are handled by the Event Management System 722. The Event Management System 722 also generates events which flow back into the Policy Engine 716 to gauge adherence to previously flagged rules. When Policies and Rules are all within boundaries, as defined by the HSM Health Service Template 812, the workflow concludes and the event is written to the Archive and Content Bus 740 for storage.

(iii) Run Book

As indicated above, the Run Book 718 stores discrete rules that are leveraged to evaluate events generated by end user activity, or more generalized system functions that initiate based on a rules violation. The Run Book 718 is accessed by the Policy Engine 716 as a result of an in-bound data event. Discrete rules are evaluative in nature and also include an “action” should the test of the evaluation be true. Supported evaluations include (but are not limited to):
Equal to
Greater than
Less than
Range

The Run Book 718 also houses discrete workflows and processes based on Health Service Template parameters. Where the Policy Engine 716 detects a rule violation, the Run Book 718 is accessed for prescribed workflows which are then leveraged by the Event Management Subsystem 722.

(iv) Health Event Management & Correlation

Health Events are key data elements that trigger workflows, data capture, and the serving of context-specific curation actions. Health Events may originate from member and/or caregiver endpoints, or they may originate from other Health Service Management cloud components. Health Events include, but are not limited to, the following:
Daily Observation: A daily observation is a member-submitted event that is the recording of an HSM requested compliance event. This could include Rx, physical activity, or any number of Disease Component indicators.
ACK: An ACK (short for “acknowledgement”) is a system generated, but member activated, event that signals a member and/or his caregiver network received notification specific to a notification. ACKs are leveraged as part of notifications for: Member Consent, billing and account update, Disease Component update, new prescriptive compliance actions, escalation notifications, and as feeders to performance management algorithms.
Workflow Actions: Workflow actions from the Policy Manager and Event Correlation/Escalation Workflows generate events which must be routed and tracked as part of potential escalation actions.
Resource Registry Updates: Members will add or upgrade their end user devices such as their phones, body attached, or person-carried biotelemetry sensors. On upgrade, deletion, and/or addition, events are generated that update the Resource Registry.

Health Event Manager data items contain four primary data elements: Event type, event status (open, closed, pending), event global unique ID (GUID), event member ID, event initiate date/time, and permitted duration. Each event is logged and tracked. On event closure, outcome is stored in data repository and made available to trending and other health care provider interfaces.

(v) Dynamic Resource Registry 720

An element of the system's networks is a cloud based service and associated process that enables a dynamic resource registry 720 service that serves a dual purpose:
1. The Dynamic Resource Registry 720 maps the member's “preference of service” relative to location of service provider, availability of provider resources and/or cost of service delivery associated to Payers and/or Healthcare Provider incentives developed to steer member consumption at time of service.
2. The Dynamic Resource Registry 720 logically associates “member centered network” assets (i.e. devices, network resources, system resources, provider resources, and caregiver resources) with Quality of Service (QoS) performance metrics such as availability, on-time delivery.

By combining rules based logic that defines availability and scheduling of a member's network resources with variables for time and location embedded in the platform's underlying extended presence protocols, the Dynamic Resource Registry 720 can assist members and providers move toward a better health care delivery model available at any given point in time. Conversely, Dynamic Resource Registry 720 can predicatively track the Quality of Service of any member centered continuity of care network resource based upon a schedule and/or health service plan and then leverage the Health Service Management process to resolve and/or escalate a non-compliance resource for intervention and resolution.

The HSM logic leverages endpoint “heartbeats” that include above referenced telemetry and time/date data and fuses with cloud based algorithms to create a “dynamic resource registry” based upon a customizable health service protocol schema defining assets and resources with relative weighted value and scheduled events. The Dynamic Resource Registry 720 enables a Quality of Service performance tracking (availability, fulfillment of contract, SLA performance) across all health service resources.

The resultant system provides service levels that scale the infrastructure, but also human response elements. The Dynamic Resource Registry 720 cloud-based logic, interface, and object store provides for, but is not limited to:
Dynamic Resource Registry: Resources are registered as part of the Disease Component Template process whereby system resources, as well as those provided by the caregiver network, are registered and now known to HSM subsystems.
Rules Logic on Network Availability, Cost, Location & Quality of Service: Allows subsystem algorithms to factor in system availability as well as endpoint resources to decision and escalation processes.
Integration with Scheduling: Optics into endpoint and cloud based resource availability provides a unique value in triage and escalation business logic. Resource indicators feed system availability allowing the system to prioritize based on endpoint needs, but also queued cloud transactions.
Customizable Based Upon Service Level Agreements: Dynamic Resource Registry 720 is also leveraged as part of the core go to market offerings, allowing for a measured and quantifiable “quality of service” approach to service levels.

(vi) Health Compliance Manager 730

The Health Compliance Manager 730 subsystem contains algorithms and tracking mechanisms to monitor a member and his/her caregivers specific to program adherence, care plan compliance and active participation. A real-time compliance score is computed based on a member's adherence to their “Medical Nutritional Therapy” (MNT) protocols which include but are not limited to safety, education, therapy, medication, lifestyle (diet, nutrition, and exercise) as well as physiological monitoring. A real-time participation score is computed based on a member's participation in their constructive, behavioral modifications which include health literacy reading, health events, and ecosystem programs.

The Health Compliance Manager also leverages a Weighted Scoring Metric based upon relevance to “health & overall wellness.” Health (e.g., MNT objects) for example, has a higher relative value towards immediate health outcomes comparative to wellness measures (behavioral and/or education). Included in Health (MNT) are immediate life safety issues. Behavioral predictors are factored in as they are indicators of the likelihood of long-term adherence to the program.

Compliance and Participation metrics are leveraged by multiple subsystems to include (but are not limited to):
Policy Engine 716: Bayesian logic in the Policy Engine 716 may use performance management metrics to drive and fine tune certain workflows, but also issue events that trigger escalation.
Event Correlation and Escalation: Health Compliance Manager (HCM) metrics will factor into whether a policy violation triggers an incident, or is moved to a problem or case which require medical professional intervention.
Diagnostic Yield: Comparing compliance results from MNT microevents relative to disease and/or condition complications progression based upon relative impact on the disease process indicator/surrogate markers (i.e. HbAlc for Diabetes).
Service Content Curation 726: HCM metrics are one of the weighted variables that drive the context specific serving of content to the member and his/her caregiver network.
Incentive and Reward Management 728: Described, below, HCM metrics are key inputs to the various rewards programs offered by and our industry partners. While the HCM system largely creates and stores daily compliance and participation scores, these scores can be aggregated over time for use with various reward levels and incentive programs offered by the system.

(vii) Incentive & Reward Management Based Scoring for Participation

As discussed above, HSM may include incentive management using, for example, module 728. Embodiments may provide a framework to incentivize the member's caregiver team not just the member. HSM may include a multi-level rewards system based upon active participation and network health literacy may encourage network participation. Exemplary ways for members of a member's support network to earn points may include, for example, taking quizzes, sharing or generating content, participating in question and answer forums, achieving certifications, bumping the member (e.g., having the support network member's computing device come into near field communication (“NFC”) with the member's computing device when the support network member visits the member), and receiving badges.

(viii) Incentive (Proactive—Sponsor Driven)
Discounts, Rebates, Subscriptions . . . Donations/Contributions—Donor Directed (Payer, Employer, Individual) Health Points

Rewards (Reactive—Network Rules Driven Based Upon Compliance & Participation)

Level Attainment Status (Silver, Gold, Platinum),
Qualifications (Badges)
Membership Points

Network Rewards—Points for Compliance, Health Literacy, & Participation
Leader Board (ability to internally or publically publish (post) status, qualifications, etc. . . . inside of caregiver team or to larger LHN network

(ix) Closed-Loop, Digital Health Consent (CDHC)

The Health Service Management (HSM) framework also provides processes that enable closed-loop digital health consent (CDHC) using a Consent Manager module 724. Consent business logic is implemented as a set of actions exposed to any workflow that requires consent or acknowledgement of a directed action. Consent business logic is implemented in the cloud, but also on edge devices (i.e., SmartPhones, tablets) providing a closed-loop service enabling health consent and verification of all elements and/or modifications to a provider directed medical, nutritional, and/or therapeutic (MNT) care plan and/or a constructive behavioral change communication (BCC) care plan.

This CDHC logic allows a HIPAA compliant, end-to-end, electronic method for routing, verifying and documenting member consent as well as caregiver acknowledgement across all elements and/or modifications to a member health plan and/or changes to a member's healthcare resources. Confirmation of a consent action can be explicit whereby the member acknowledges an action, or implicit, whereby the mere action or reading an event signals a background acknowledgement.

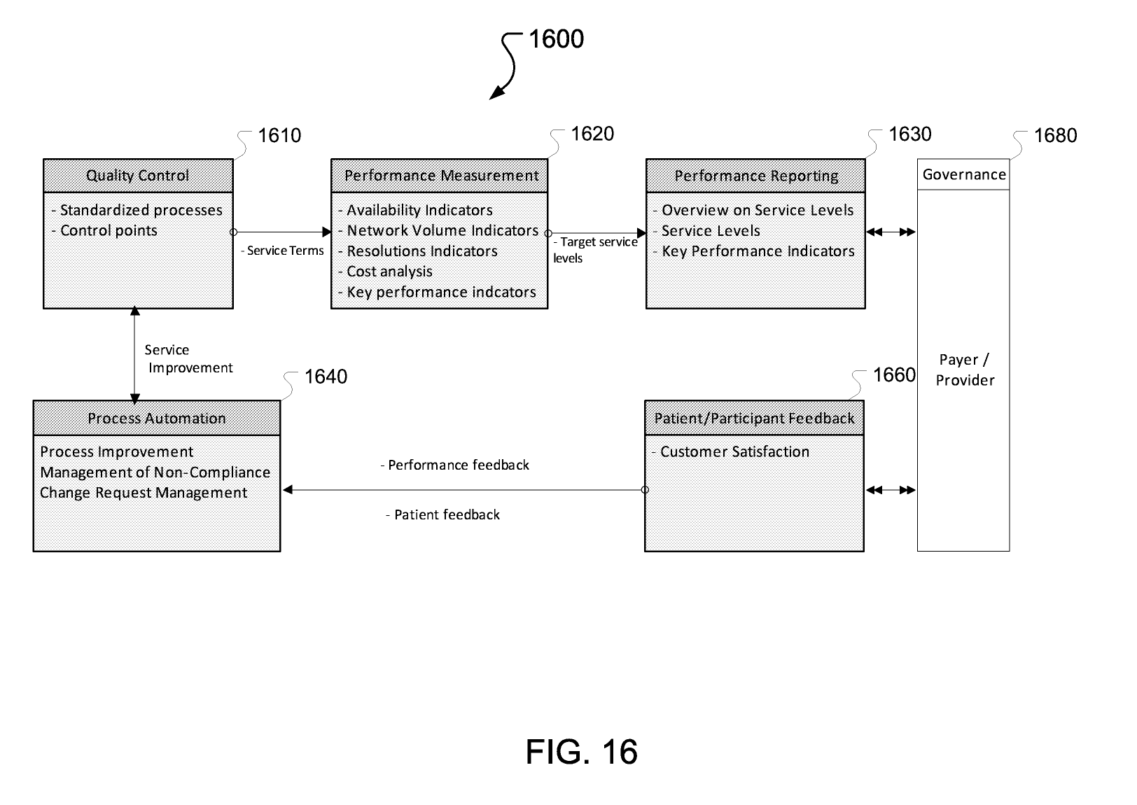

This consent process is extensible across the entire Health Services Network and can be leveraged by any number of health service events that include, but are not limited to:
Provisioning and Privacy: During provisioning, the member and/or trusted caregiver network may extend access to their medical information and/or Disease Component actions. Consent may be leveraged here to confirm that the member approves access by third parties.
Health Insurance Portability and Accountability Act Compliance: The member may be prompted for approval and consent to allow third-party providers to review and/or make additions to the member's electronic medical records (EMR).
Billing and Cost Recovery: When billing changes are made to a member account, the member may be prompted to approve said changes.
Disease Component update: When the health care provider makes changes to regimen, the member is prompted to acknowledge and give consent that he/she reviewed said changes (see HSM Component FIG. 8a, Disease Component Templates).
Performance Management: Incentives and rewards are core to the solution. The member may be prompted at times to approve and give consent to the movement of rewards between trusted caregivers. As well, the member may be prompted for approval and consent to allow third-party reward providers to send information (see HSM Component FIG. 16, Performance Management).

This CDHC logic leverages client-side authentication infrastructure combined with cloud-based directory services to establish a secure and authenticated trusted link as a verifiable “chain of consent” between the member's client-side device with the clinical infrastructure supporting the professional healthcare provider. The CDHC process extends this “chain of consent” out to the member's trusted caregiver network devices, if applicable, to enable full transparency of the health service process.

The CDHC logic enables providers to ensure member consent across all elements of a directed health care plan as well allowing providers to demonstrate “meaningful use” of health information technology in support of ongoing ONC regulatory requirements for modernization of health care infrastructure.

CDHC functions are enforced using a number of methods that include, but are not limited to:
Chain of Consent: Policy Engine 716 directed workflow processes that require consent by multiple caregiver network roles.
Straight Through Processing (STP): Non-human methods to move and acknowledge system events using user interface gestures versus explicit user consent.
User Authentication: Native endpoint authentication provider that leverages asymmetric protocols for authentication, fused with center-based directory services for assured authenticated consent.
End to End Encryption: Cloud-based “encryption at rest” extending to the member devices using AES-256-bit encrypted sessions to move consent actions back to the HSM cloud.

(x) Service Content Curation 726

The explosion of health information has led to an apparently overwhelming amount of content, making it difficult for members and their caregivers to locate the best and most credible content. In this system, the Service Content Curation module 726 houses vetted information that is meta-tagged with a series of codes allowing the right content and services tailored to Medical Nutrition Therapy and/or Constructive Behavioral Modification. Content is pushed based on availability or expressed desire. Service Content Curation module 726 frees the member and his/her caregivers from having to sift through mountains of un-vetted content.

The HSM Service Content Curation 726 pushes timely and relevant information on health topics based on weighted variables that include (but are not limited to):
Disease State: Content that is specific to the chronic condition of the member and his/her caregiver network.
Disease Component Guidelines: Content that is weighted consistent with the goals of the prescribed indicators. If the indicators are skewed towards weight loss, content is in the context to the diseased state, but with an emphasis on encouraging exercise and/or diet (for example).
Member Compliance Score: If the Member Compliance and/or the Performance Management scores are low, provide contextualized content that provide incentives for specific behaviors.
Date, Time, and Location: Provides content based on above indicators, but also in context with the time of day and possible the location. An example might be a member who out of compliance for diet. The system can present content that provides guidelines and incentive to eat a healthy lunch.

Content from Service Content Curation module 726 is pushed on a predetermined interval as stipulated by the Disease Component Template. Content use is tracked by the Consent Manager to measure whether the member is participating in their outcomes given the high value of relevant health education content. Service Content Curation module 726 items are pushed based on the following (but not limited to) scenarios:
Content that encourages attainment of reward levels for member and informal caregiver network based on compliance scoring housed in the Performance Management and Incentive & Reward Management subsystem 728.
Recent events and any escalation events: Policy Engine 716 directs more finely tuned content based on recent escalation events as correlated to Disease Component rules, actions, and workflows. This allows time sensitive content to be sent based on what is going on “now” versus generic, one-size fits all content.
Relatables: Service Content Curation module 726 pushes content that leverages member specific meta-data that is more lifestyle and age related. if member is youngster, leverage EIF spokespeople that fit age group for encouragement to adhere to therapeutic regimen. Also include serving of content specific to time and location.
Services tailored to Themes based upon Medical Nutrition Therapy and/or Constructive Behavioral Modification BASED upon availability or expressed desire.
Targeted Programs: One example being Fit for Life (Health Literacy/Wellness/Behavioral Change)

(xi) Archive and Content Bus 740

The HSM Archive and Content Bus 740 is a scalable and preferably fault tolerant data “bus” that provides storage and retrieval interfaces to all HSM subsystems and enables different information movement. The bus supports two (2) internal and one (1) external cloud interface(s):
1. Put (Internal): Any HSM subsystem may post information for use by the system, or, for historical purposes. It is important to note that ALL external events are routed through HSM logic for assurance prior to being posted to HSM information store(s).
2. Get (Internal): Any HSM subsystem may query information needed by the system for autonomous actions, or, as part of higher level reporting and trending algorithms. It is important to note that ALL external requests are routed through HSM logic for access control enforcement prior to being pulled from HSM information store(s).
3. Business API (BAPI) (External): BAPI's are higher level groupings of put and/or get interfaces that provide aggregated content that can push or pull from external systems and/or health care provider systems. BAPI's are implemented using “plug-ins” that allow for rapid adaptation and extensibility. All BAPI's are “signed” for authenticated access to HSM subsystems.

The Archive and Content Bus 740 repository types include, but are not limited to:
Data 750: These stores house content that has been received and/or generated by HSM cloud subsystems such as Policy Manager, Rules Manager, etc.
Logs 752: These stores house records of transactions as well as system performance
Business Analytics 754: These stores house ad-hoc and scheduled reports generated by the system and/or analytics subsystems for distribution to health care professionals who may or may not have information technology infrastructure. This repository also houses system level reports as to the performance and compliance of the system during a predetermined timeframe.

HSM Archive and Content Bus 740 also provides an extensible Health Care Provider Interface framework 760 for the creation of “Business APIs” (or BAPIs) which provide for extensibility and rapid adaptation. These BAPI types include, but are not limited to:
EMR 762: Plugins built to support bi-directional information and event exchange with enterprise Electronic Medical Records systems providing seamless information and process integration.
Business Analytics BAPI's 764: Plug-ins that provide interfaces to data marts for ad-hoc or standard reporting.
pNOC 780 BAPIs: 766 Plug-ins that provide data flows for medical professionals using the Member Network Operations Console. The system plug-ins contain unique algorithms that scales health care resources providing a real-time virtual “triage” of chronically ill or non-compliance members.

(xii) Member Network Operations Console (pNOC) 780

An element of the system is a dynamic, member network operations console (pNOC) 780 for client side decision support, triage and health intervention by a medical practitioner and/or a caregiver member supporting one of more individual members. The goal of the pNOC 780 is to scale the delivery of health care by providing a real-time and dashboard of those members who are not adhering to protocol and who may be at risk for hospitalization or life threatening event.

The pNOC's client-side logic is fed from the cloud based Health Service Management framework for event management and escalation enabling the creation of a “dynamic member registry” built upon a personalized dashboard interface and prioritization schema defined by the role. This dashboard is delivered to the health care practitioner in context to their role in the delivery of care. The pNOC 780 consider the role of the user (i.e., Nutritionist, Specialist, Nurse Practitioner, and/or Doctor) and provides an aggregated and triaged view based n indicators that are of most importance to the care provider using the dashboard.

Additionally, the pNOC 780's dashboard interface can be customized to prioritize the member registry based upon role of healthcare response, health conditions, criticality of conditions, as well as the availability and location of health resources.

pNOC 780 logic enables dynamic filtering and prioritization of the member registry allowing the practitioner and/or trusted caregiver to triage and intervene based upon functional role, expertise, relevance, and/or availability and location of resource.

The pNOC 780 is provided content, in context to role, location, and service level, by a published interface provided by the Health Care Provider Interface subsystem as provided by the Archive and Content Bus 740.

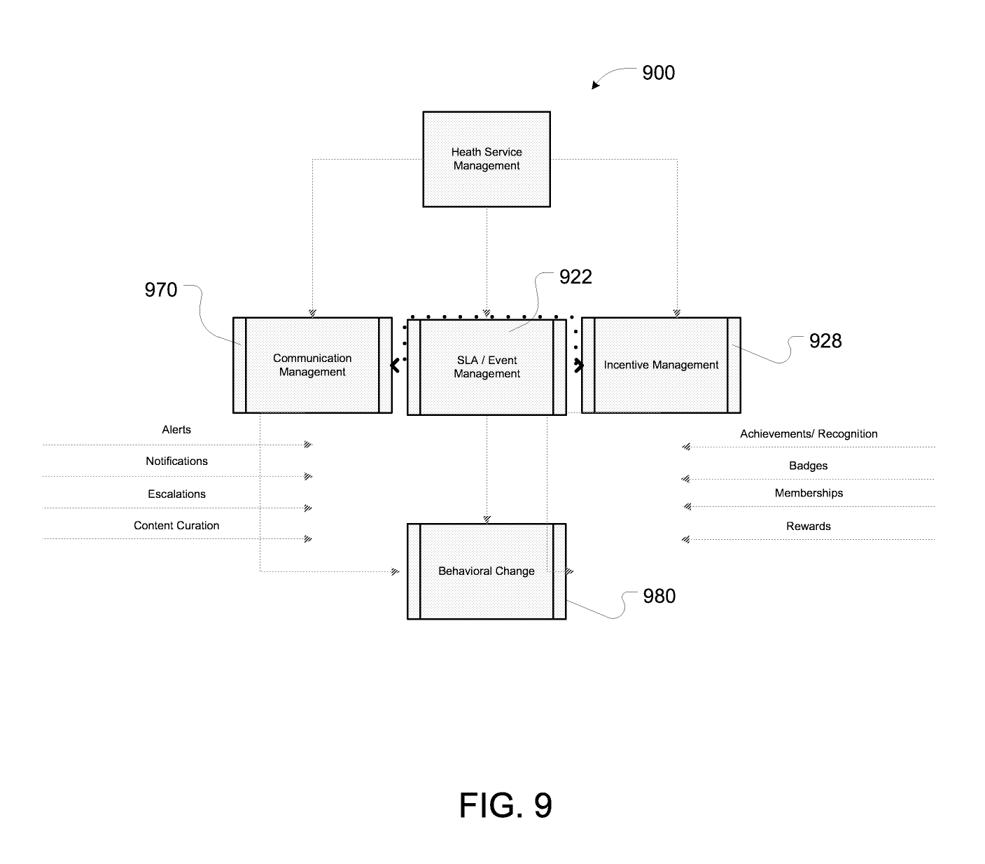

In a simplified form, therefore, and as illustrated in FIG. 9, the HSM 900 model combines an Health Event Management System 922 (i.e., a system that handles escalation and problem resolution logic) and Communication Management Systems 970 with an Incentive Management System 928 (i.e., a multi-level network reward system to incentivize caregiver participation across the health care delivery spectrum) to affect behavioral change 980 to help a member live healthily. FIG. 9 illustrates the interaction of HSM 900, Communication Management 970, Event Management 922, and Incentive Management 928 to bring about Behavioral Change in a member.

Touching on all the lifecycle processes within continuity of care outside the institutional setting, HSM is a way to bring together many disparate processes and tools to create quantifiable improvement in medical treatment quality and/or efficiency (Quality of Care (“QOC”) and Service Level Agreements (“SLA”)) and the ability to view technology as it is germane to health delivery process.

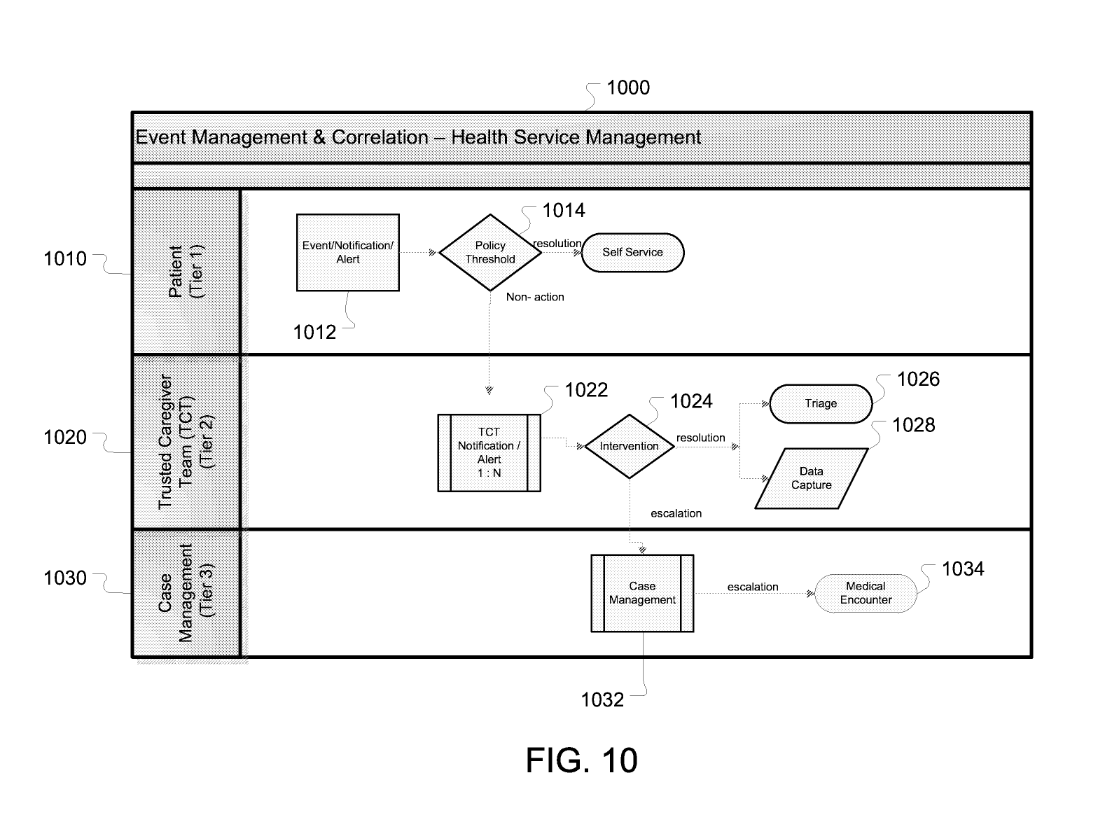

FIG. 10 shows an exemplary HSM intervention and escalation chart. The intervention and escalation chart illustrates an exemplary process for detection of a member 1000 event and handling of the event as it may escalate through multiple tiers. At an initial member level 1000 (i.e., tier 1), an event, notification, or alert 1012 may initially trigger a policy threshold 1014 of the HSM. For example, the member may be given a set period of time to fill out a health literacy test relating to a condition specifically relevant to the member. Upon meeting the policy threshold by delaying in filling out the test until after a threshold date or time, the member's device may alert the member of their failure to fill out the test. The member may then resolve the event by filling out the test. Alternatively, if the member does not fill out the test, or if a series of similar “correlated” events occur, the event(s) may be reclassified as an “incident” escalated by the system and a BCC may be provided to the caregiver team (“TCT”) (i.e., tier 2) 1020.

At tier 2, a BCC (e.g., an alert 1022) may be provided to one or more members of the member's TCT. The TCT members may be close friends or relatives of the member previously designated by the member as those the member wishes to share their information with. In other words, the TCT may be a human network of those who can provide support to the member connected by a physical network of operatively coupled devices (i.e., a member-centered CCN) configured to distribute alerts if designated to do so by the member. Such escalation provides a 1:N support group; in other words N members of the TCT may support a single member in response to the “incident”. One or more members of the TCT may then intervene 1024, for example by contacting or visiting the member to provide support (e.g., to encourage the member to take the health literacy test). The resolution may involve, for example, triage 1026 or data capture 1026. If the incident is not resolved, it may be escalated based upon a pre-defined set of rules to the status of “problem” within case management (i.e., tier 3) 1030. In this tier 1030, a case management process 1032 may look for resolution of the problem or escalate the problem to the status requiring a medical encounter 1034.

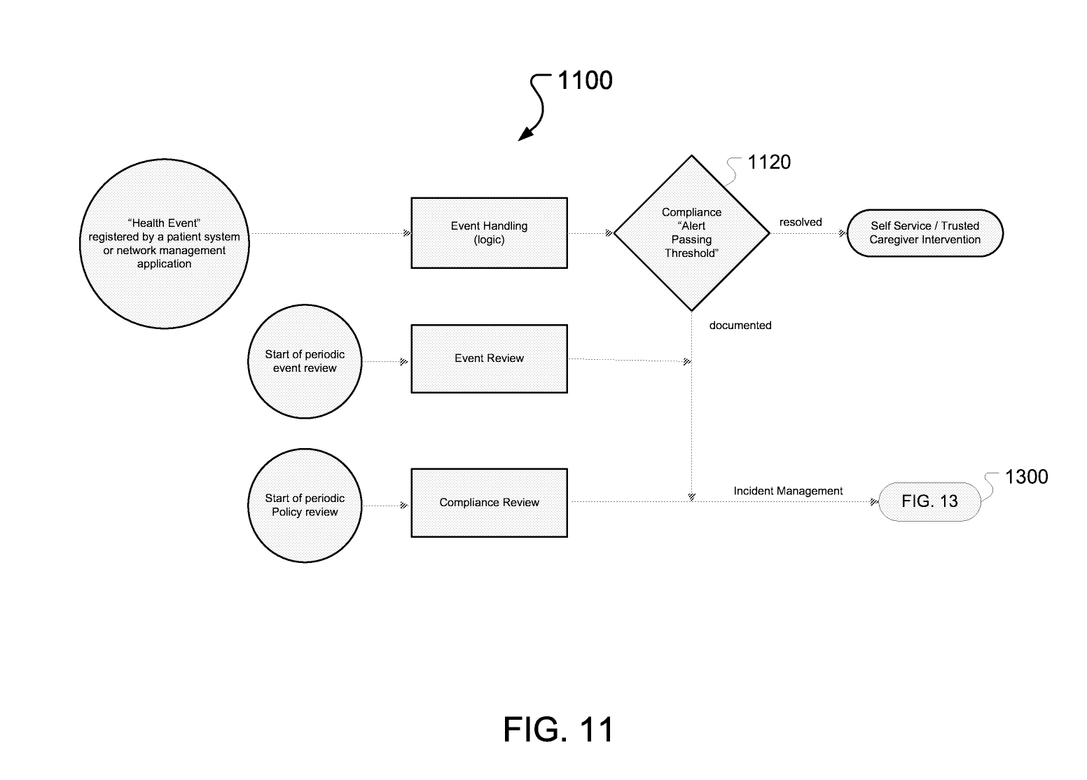

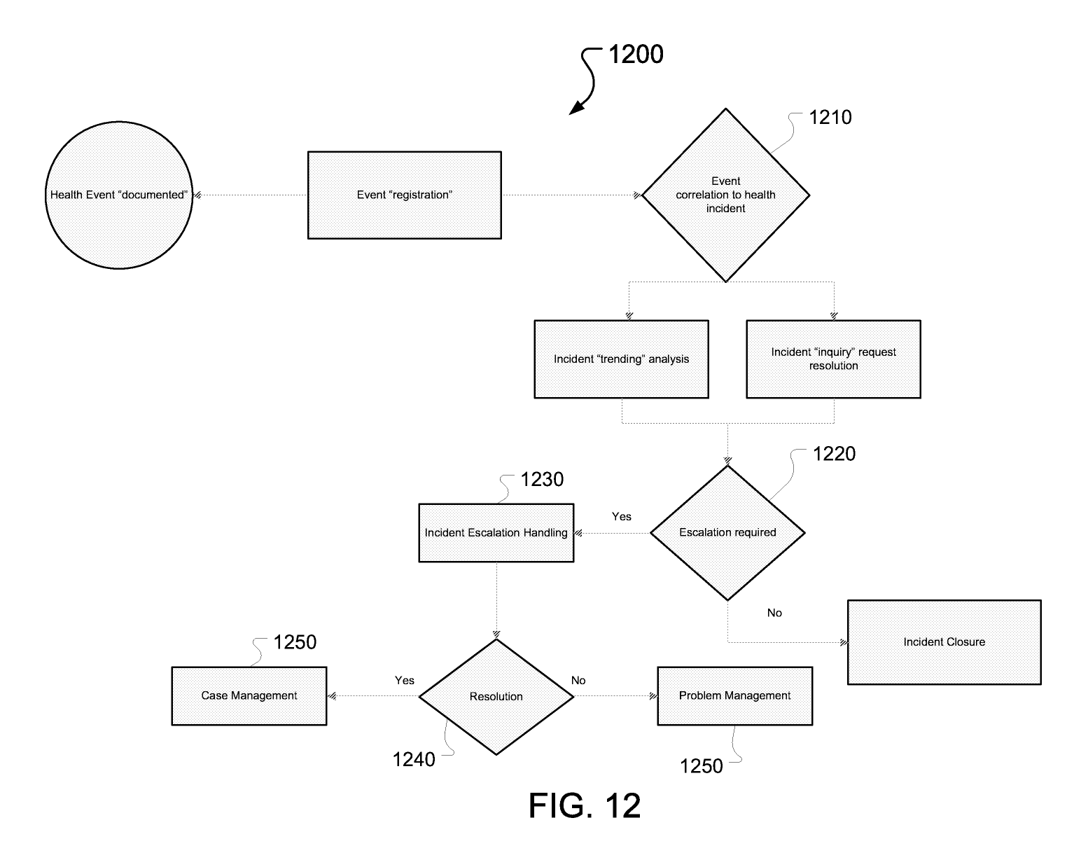

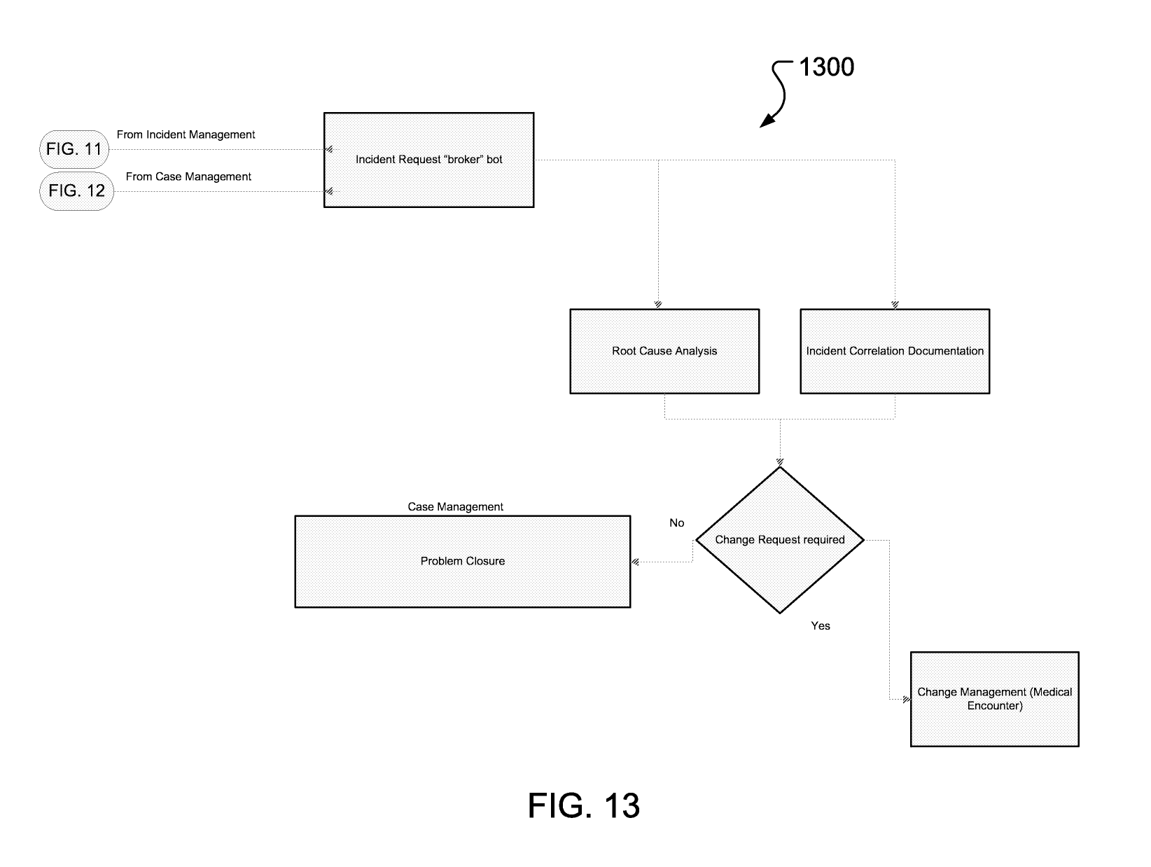

FIGS. 11 through 15 illustrate exemplary detailed workflows for health event handling and escalation. FIG. 11 illustrates an event management process 1100 that may be triggered in response to a health compliance “event” registered by a member system or network management application. If the health compliance event is determined to pass a threshold limit 1120, an exemplary incident management process 1200 illustrated by FIG. 12 may determine whether the event correlates to a health incident 1210. If the event correlates to a health incident, the process may proceed to determine whether escalation is required 1220. Finally, if the process determines that incident handling 1230 is required, the process may determine whether the health incident has been resolved 1240. If the incident has been resolved, the process may proceed to a case management process 1250, otherwise the process proceeds to a problem management process 1260. In other words, the incident management data flow may facilitate member-activated support network (e.g., family, caregiver, etc.) and support network to member communication and, if the incident is not resolved, escalate the health incident.

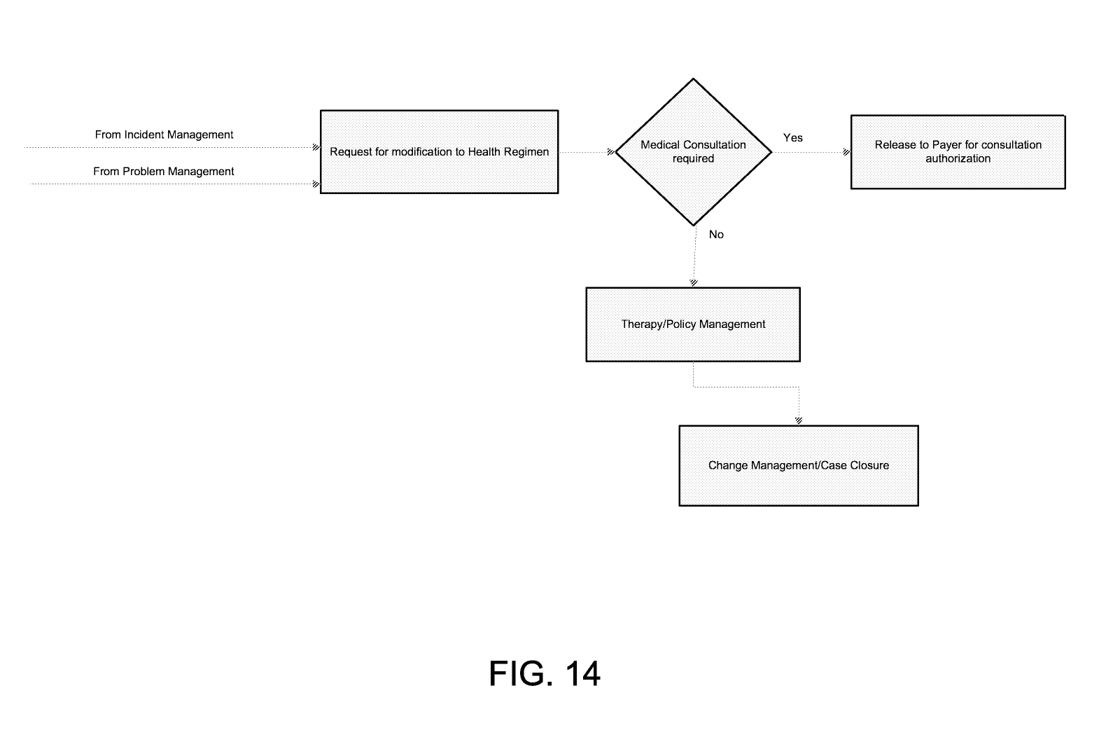

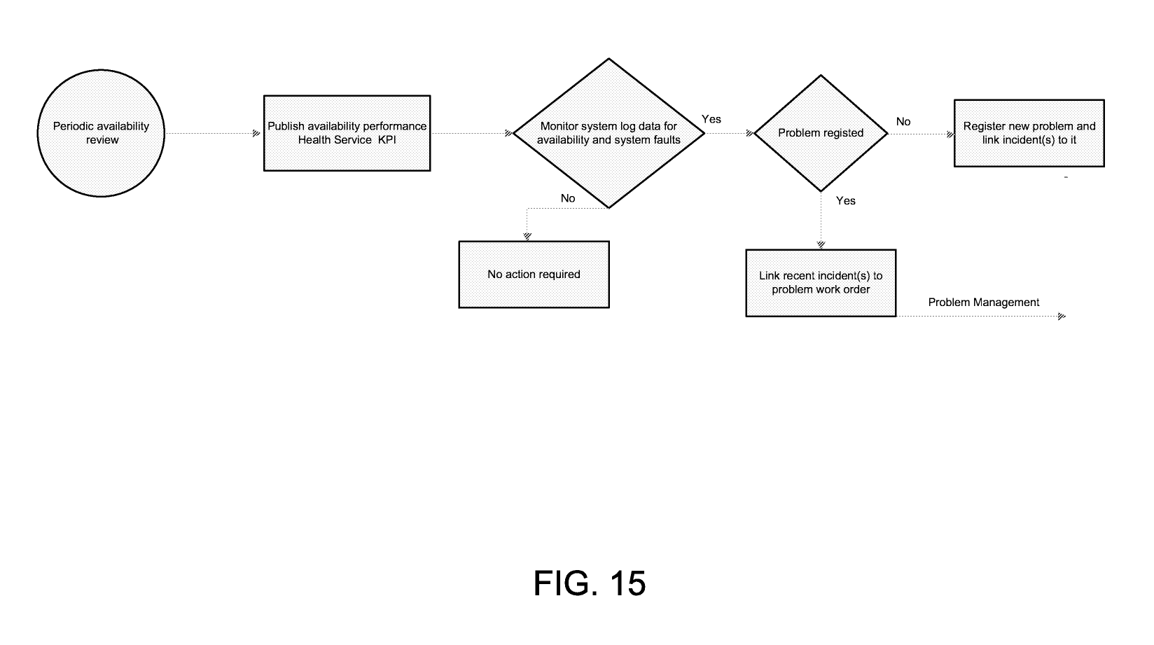

FIG. 13 illustrates an exemplary health change problem management process 1300 configured to provide data flow and process escalation between member CCN and provide a network system. FIG. 14 illustrates an exemplary case management process for providing an automated work order (e.g., health intervention) automation. The case management process may provide a unidirectional data flow from the payer to provider and health network systems, for example via an Electronic Data Interchange. Finally, FIG. 15 illustrates an exemplary system availability process configured to monitor and publish availability and performance of the system.

As one or more events may be escalated to incidents, problems, change request, and change authorizations, data transmitted through the workflows may include historical data relevant to related events, incidents, and problems. For example, if an incident (e.g., a member not taking a medication) triggers a BCC to members of the TCT, the BCC may include historical data relevant to related events (e.g., the BCC may indicate that this is the third time the member has been late taking a medication this week, thus even though the member took the medication without outside support from a member of the TCT each previous time, it may be supportive to reach out to the member and discuss the importance of timely medication).

Embodiments may also provide a Health Service Support (“HSS”) system. A HSS system may focuses on member services and ensure that the member has access to the appropriate services to support the continuity of care functions. To a member-centered support team, members are the entry point to the process model. They may get involved in health service support by asking for changes, needing communication or updates, having difficulties or queries, or experiencing non-compliance events/incidents.

FIG. 16 shows a higher level view 1600 of an exemplary workflow components for performance of various functions of the HSM system and how these inter connect. As can be seen, the HSM has a quality control component that includes a standardized process and specific control points in the system. This feeds into a Performance Measurement component 1620. This component is concerned with issues such as availability, network volume, resolutions, costs analyses and other key performance matters. Various indicators for these can be produced by the system. The performance measurement component 1620 feeds into a performance reporting component 1630, which can provide reports (either detailed or in overview) of Service levels and other key performance indicators. These reports can be created independently or based on predetermined target service levels.

The Quality Control system 1610 also feeds into a Process Automation component 1640. The process automation component also receives inputs from a patient/participant feedback component 1660. This feedback component 1660 provides information on performance, for example. Also, as is shown, a two-way communication can be established between the performance reporting component 1630 and the feedback component 1660, on the one hand, and a Payer/Service provider system 1680, on the other hand.

### (h) Network Rewards Framework

As discussed above with reference to FIGS. 7 and 9, the HSM may include incentive management. Embodiments may provide a framework to incentivize the member's trusted caregiver team (also referred to as trusted social network) not just the member. Multi-level rewards system based upon active participation and network health literacy may encourage network participation. Exemplary ways for members of a member's support network to earn points may include, for example, taking quizzes, sharing or generating content, participating in question and answer forums, achieving certifications, bumping the member (e.g., having the support network member's computing device come into near field communication (“NFC”) with the member's computing device when the support network member visits the member), and receiving badges.

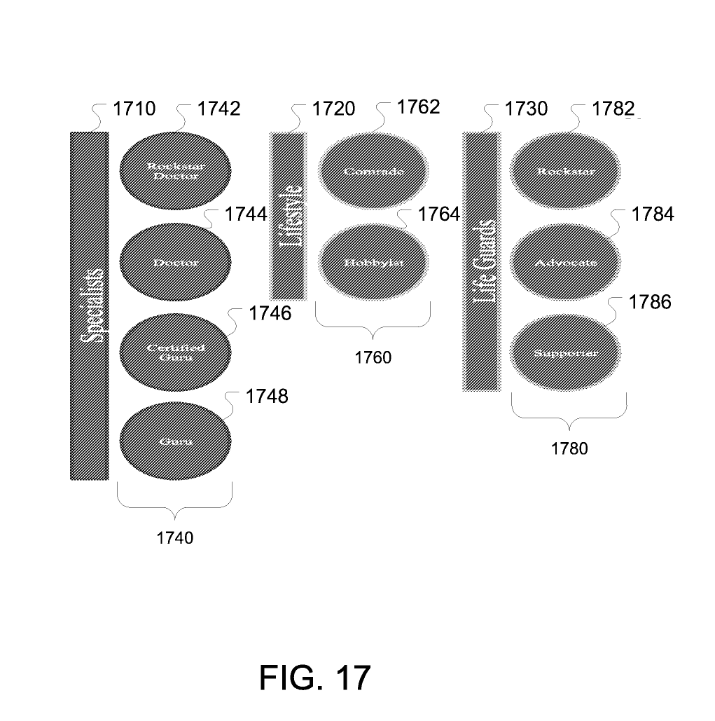

FIG. 17 illustrates exemplary badges that may be awarded to various members of a member's TCT. Badges incentivize active participation in the network by giving support network members achievable goals and tasks that satisfy natural human desires. These include status, achievement, competition, and altruism. As shown in FIG. 17, badges may be provided in three categories, namely specialists 1710, lifestyle 1720, and life guards 1730. Each category may contain badges that indicate a network member's achievements 1740, status 1760, and the ways they are participating in the network 1780.

The specialist category 1710 may provide badges to network members who have specialized information relative to the network. The rockstar doctor badge 1742 may be awarded to members of the network who are registered as doctors, contribute answers to question and answer forums that are considered valid and useful, and contribute and share verified content on the network. The doctor badge 1744 may be awarded to all other registered doctors on the network. The certified guru badge 1746 may be awarded to members of the network who have registered certificates as described in a certifications feature for the specialization, have contributed answers to question and answer forums that are considered valid and useful, have contributed and shared verified content on the network, and have completed an advanced level quiz. Finally, the guru badge 1748 may be awarded to members of the network who have contributed answers to question and answer forums that are considered valid and useful, have contributed and shared verified content on the network, and have completed at least the intermediate level quiz.

The lifestyle category 1720 may provide badges to network members how have similar lifestyles to the member. For example, a comrade badge 1762 may be awarded to members of a member's network who have the same illness as the member. Additionally, a hobbyist badge 1764 may be awarded to a member of a member's network who partakes in similar sports, hobbies, or other recreational activities as the member.

The lifeguards category 1730 may provide badges to network members who participate actively in a member's care network. For example, a rockstar badge 1782 may be awarded to a member of a member's care network who receives status updates, actively checks the member's status 4-7 times each week, and bumps with the member frequently. An advocate badge 1784 may be awarded to a member of the member's care network who receives status updates, actively checks the member's status 2-3 times per week, and bumps with the member frequently. Finally, a supporter badge 1786 may be awarded to a member of a member's care network who receives status updates.

Of course, these badges and badge categories are exemplary only. Embodiments may include additional or alternative badges and badge categories to provide incentives for active participation in support networks.

Additionally, while points and badges may be great motivators on their own, embodiments may allow members of support networks to earn gifts based on a total number of points and/or badges received. For example, gifts may include charitable donations or redeemable discounts at partners of the system supporting the network.

Embodiments may also provide for a leader board. A leader board may provide a ranking of top performers in at least one of a member's support network and globally across the entire system. Leaders may be ranked for any number of categories, for example most points, most badges, most charitable donations, and the like.

To keep network members informed of what is going on with the member they support as well as what is going on in their network, the network may send notifications of various events. For example, a digest may be sent to each network member's device periodically (e.g., daily, weekly, or on custom intervals) that includes information about the member's status and condition as well as recent achievements (e.g., quiz completions, new badges, new user generated content, etc.) of network users. Additionally, critical system updates may be sent instantaneously when the member has critical health changes. Depending on the severity of the update, an alert may also be sent to emergency services. General updates relating to the member's status may be sent at a frequency and time of day defined specifically for each member of the network. Of course, additional notifications may also be sent.

Embodiments may also include a rewards point system. Embodiments may include a debit account conversation data store on the member's device to identify rewards points that may be spent for health services, for example to fill prescriptions at a CVS Pharmacy. A member may earn rewards points in conventional fashion through their credit or debit card (e.g., a member may earn AMEX points from their own source accounts). Members of a member's TCT may also donate points to the member from their own source accounts. A client device may utilize data in the debit accounts conversation data store to interact with a point of sale system to redeem the points. For example, a near field communication (“NFC”) connection may be made with the point of sale system to use the points (rather than a financial transaction) to pay for health related products or services.

### (i) Channel for Directed Content Curation

Content curation generally refers to the process of leveraging subject-matter expertise from services with higher levels of education on a particular subject matter in order to provide a higher level of context and relevance related to content, information, and knowledge sharing. Embodiments may provide a communications gateway/channel for highly secure, consent based medical information curation linked to health experts from multiple sources such as provider resources, payer resources, non-profit member advocacy resources, pharmaceutical resources, as well as government resources (e.g., surgeon general, NIH, FDA, etc.).

Medical information curation may include information being pushed and access granted to trusted 3rd party curators to the health network system based upon member or extended network's interactions and or queries. A medical information curation algorithm may perform a look-up to a classification “queue” for just in time information curation (parsing for relevance and distribution).

### (j) Member & Trusted Caregiver Team: Mobile Client Dashboards and Analytics

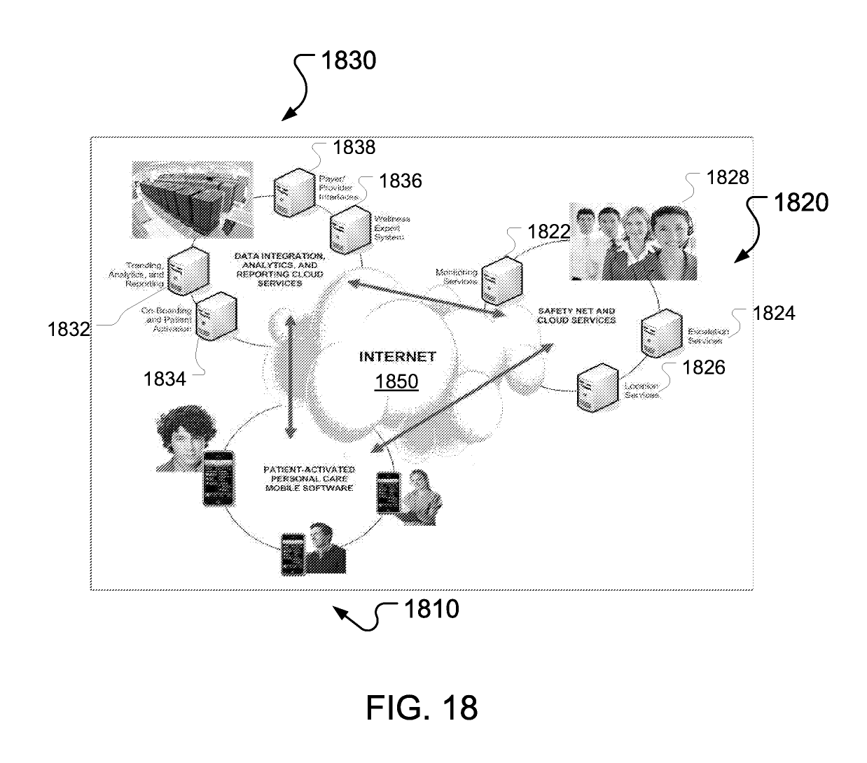

FIG. 18 shows an exemplary system overview of a member-activated mobile health network similar to the CCN shown in FIG. 1. As can be seen, it shows members (in this case patients) 1810, with communication capabilities among themselves, their safety net services 1820 and data integration, analytics and reporting services 1830. The safety net services 1820, could for example, include services for monitoring 1822, 1824, and location 1826. It could also include actual human beings 1828. Services 1830 can be cloud based, for example. They include facilities for, for example, and include Trending, other analytics and reporting 1832, On-boarding and Activation 1834, a wellness expert system 1836 and a payer/provider interface 1838. All these various components can communicate with each other ion a “peer-to-peer” basis over a network, private or public, wireless or fixed line.

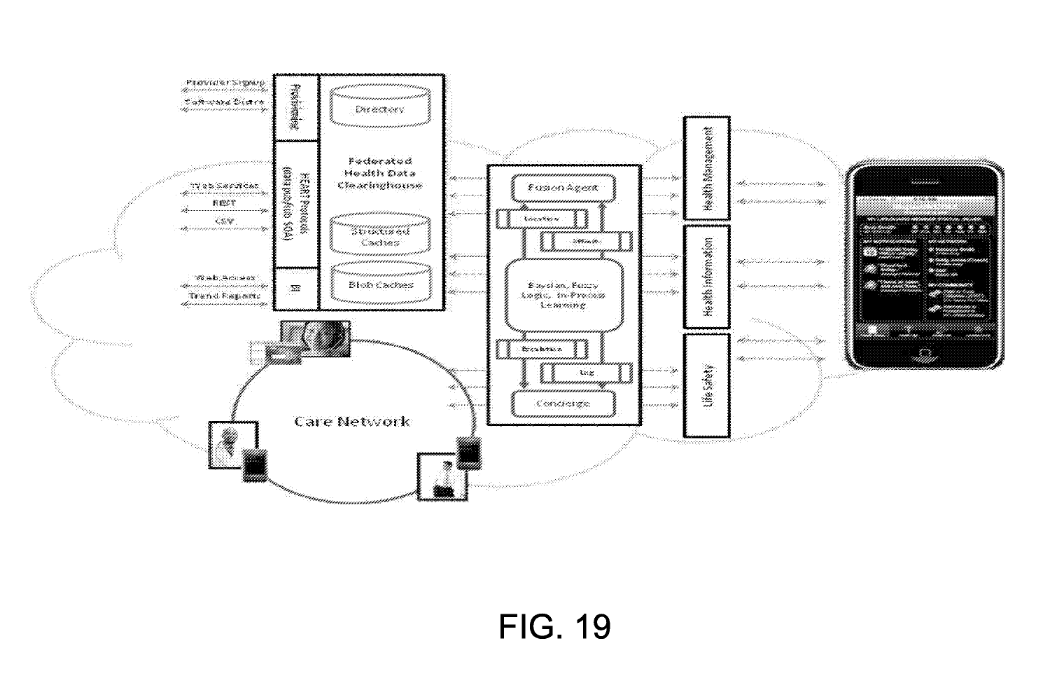

FIG. 19 shows an exemplary master topology of a CCN utilizing a fusion agent.

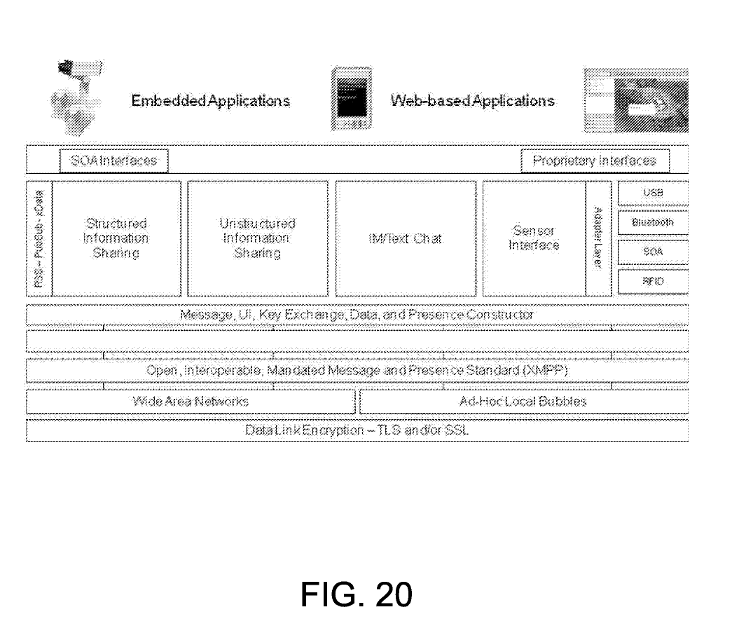

FIG. 20 shows and exemplary functional stack and functional interfaces for embodiments to run on top of a fusion agent.

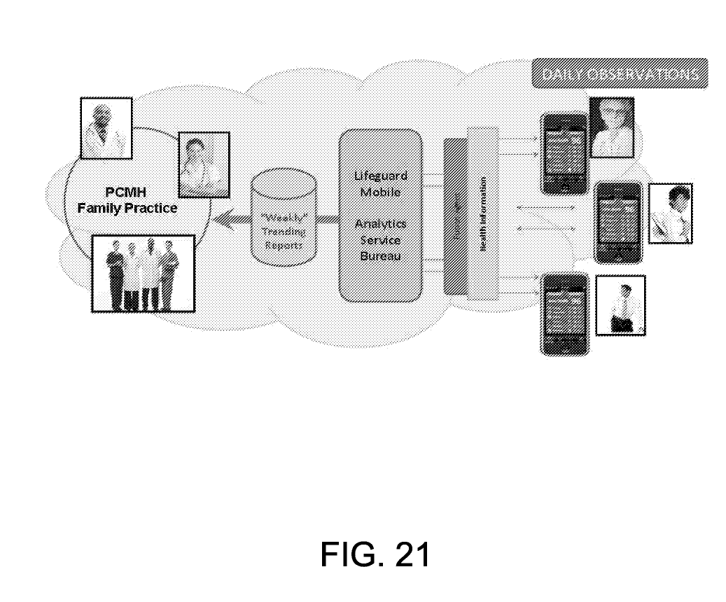

FIG. 21 shows an exemplary workflow for embodiments to provide trending reports, for example to a primary care provider. Of course, while the workflow illustrates “daily observations” and “weekly reports”, observations may be taken more or less often and trending reports may be generated spanning any amount of time or number of events. The user interface screens utilized for observations may be any user interface screens configured to receive member input.

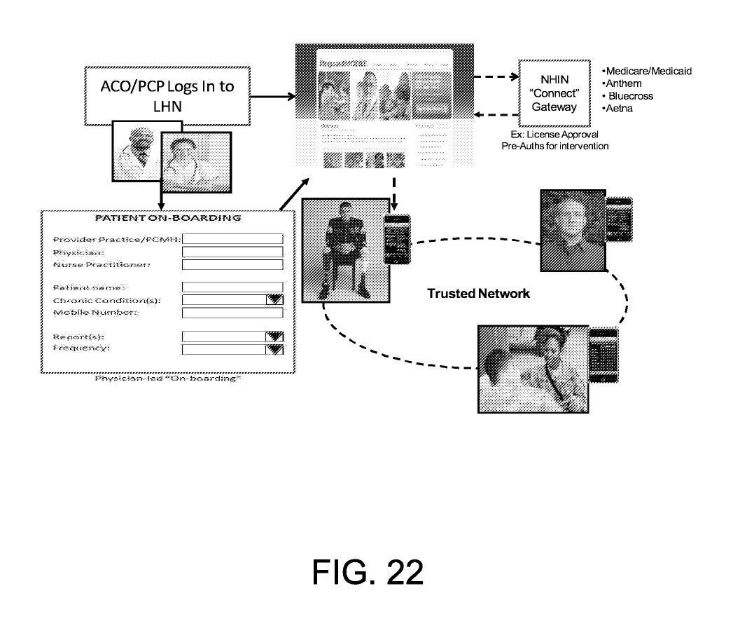

FIG. 22 shows an exemplary system for member on-boarding. For example, the system of FIG. 22 may utilize a process flow similar to that shown in FIG. 2 to perform physician-led onboarding.

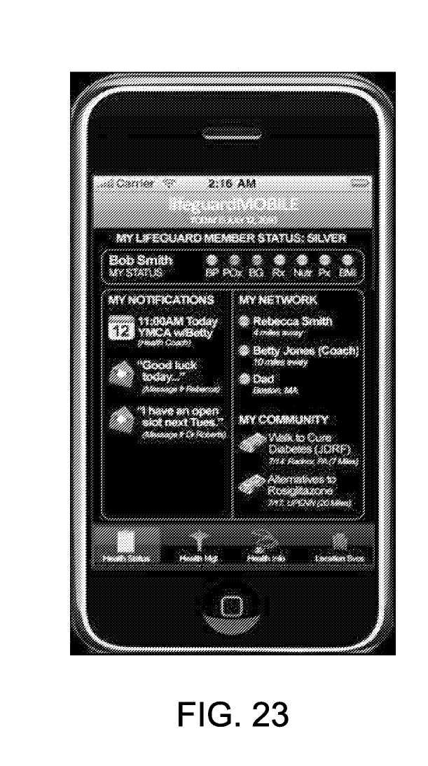

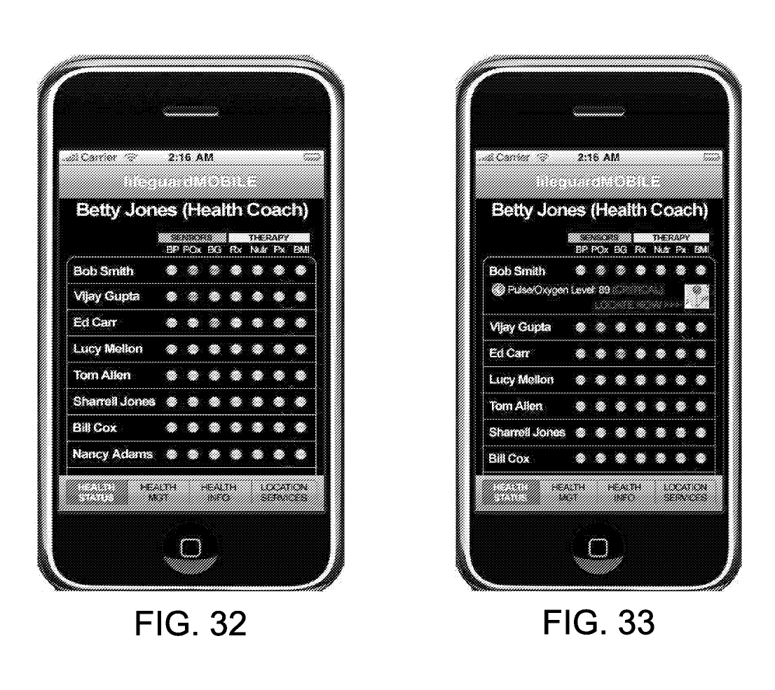

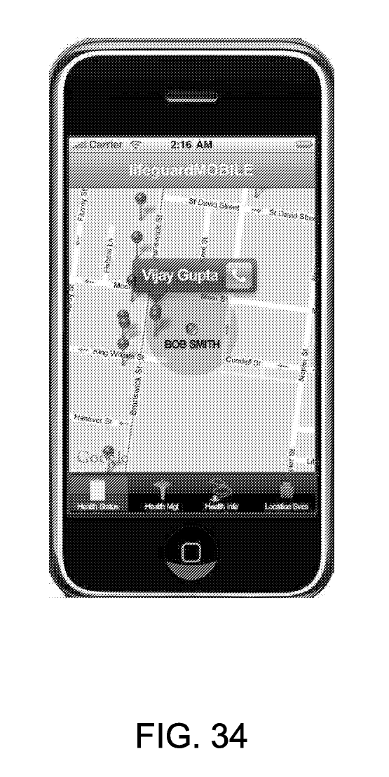

FIGS. 23-36 illustrate various exemplary user interfaces on a mobile device to allow a member to interact with their computing device, to display data to a member; to interact with a payer or provider, and to interact with other devices in a CCN.

Specifically, FIG. 23 illustrates an exemplary home screen for a member to see their status (e.g., including information read from sensors coupled to the device), messages (e.g., from TCT members), and information about others in their network (e.g., LBS information). By virtue of the decentralized CCN, embodiments may provide the member with relevant data even when the member's device cannot communicate with a central server.

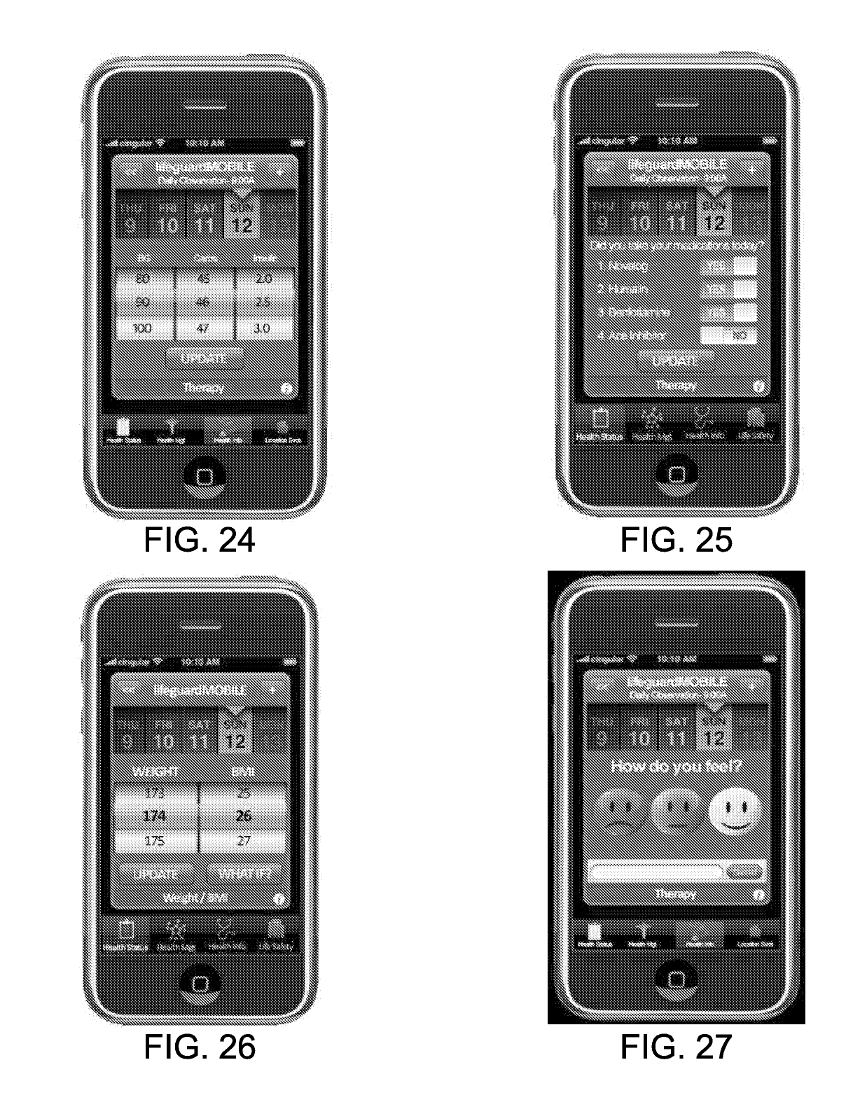

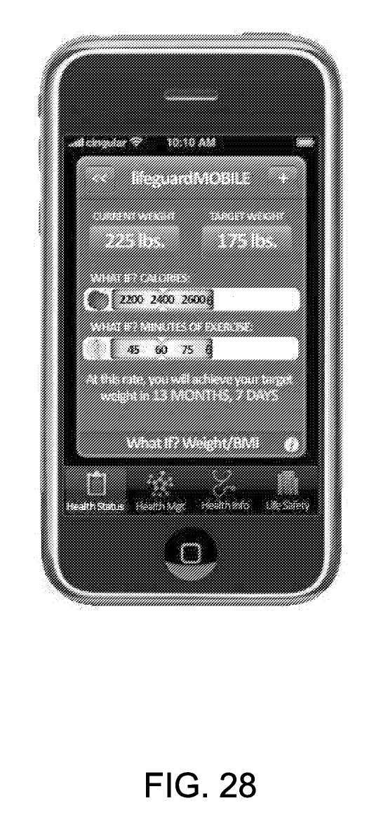

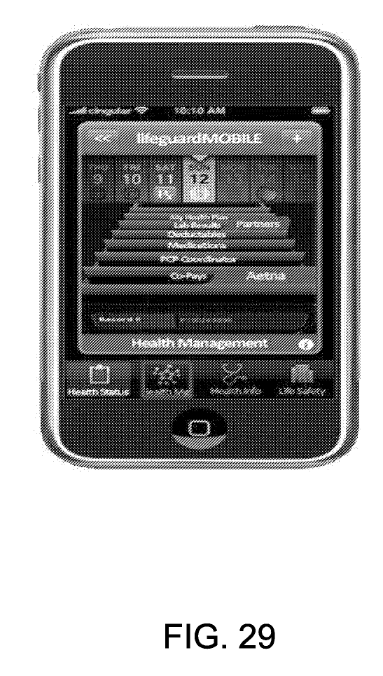

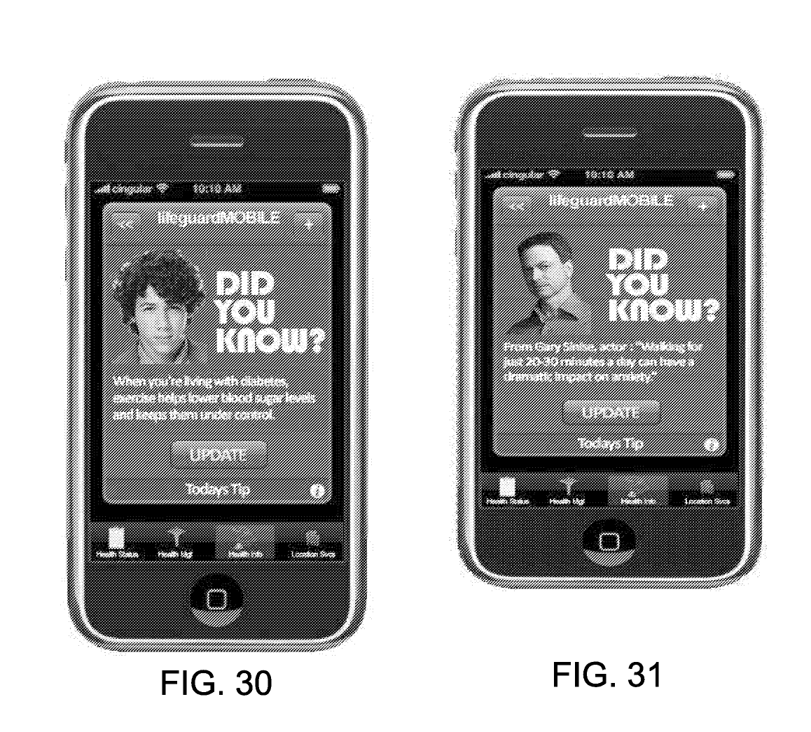

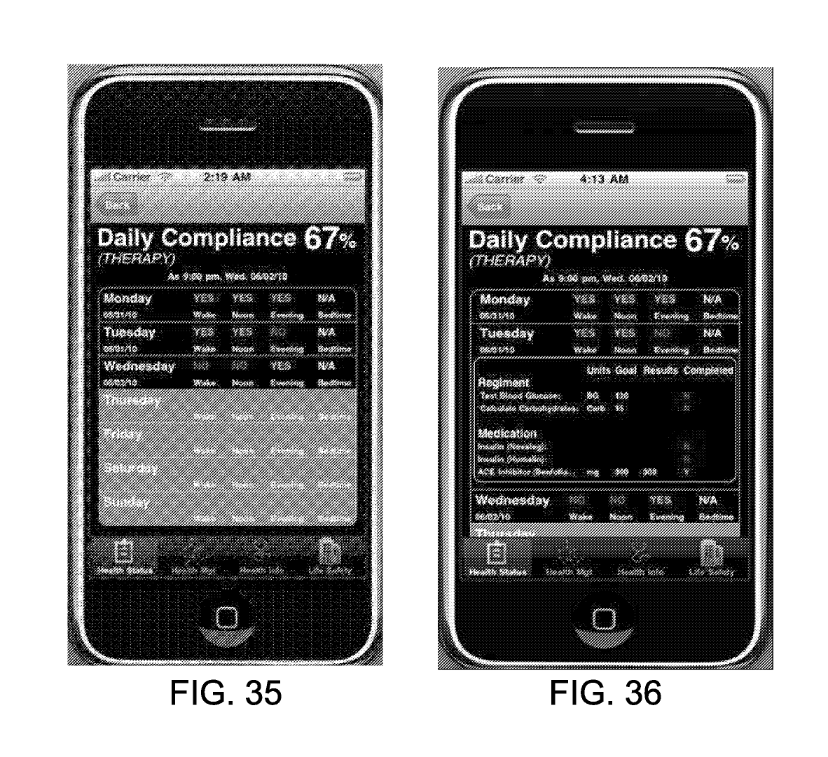

FIGS. 24-27 illustrate member dashboards for data capture from a member. FIG. 28 illustrates a goal setting and predictive analysis interface. FIG. 29 illustrates a member dashboard to provide member access to integrated health management systems, such as payer or provider integrated data files, electronic medical records, or other pertinent health or financial records. FIGS. 30-31 illustrate exemplary member network operation console (“pNOC”) screens. FIG. 33 illustrates an exemplary TCT member dashboard showing member-centered location-based resources and services. FIGS. 35-36 illustrate TCT dashboards showing member compliance and adherence with therapy.

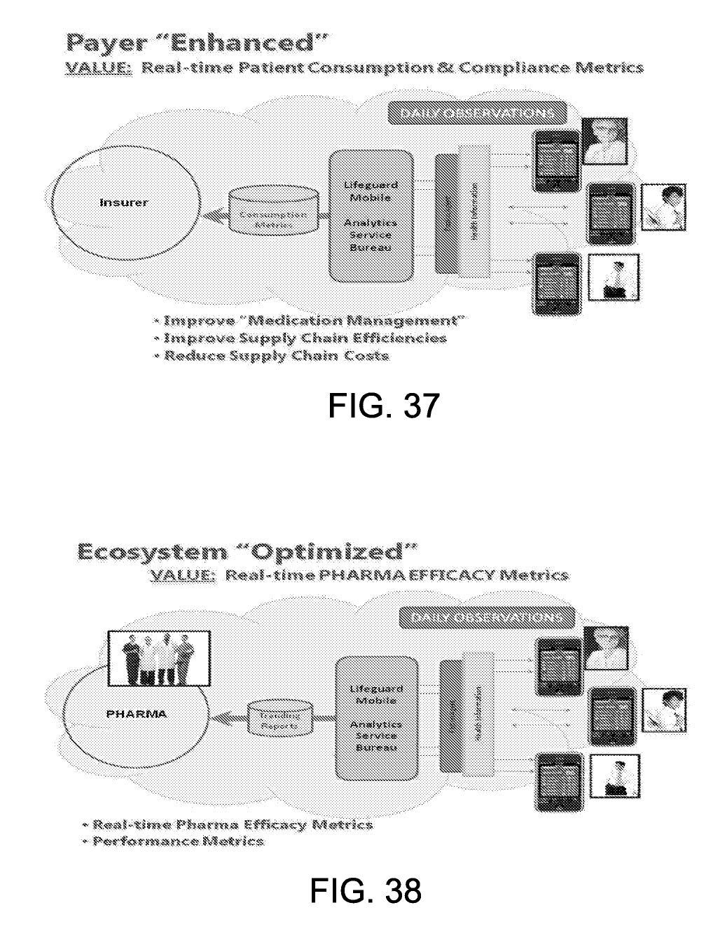

FIG. 37 illustrates an exemplary workflow for providing real-time point-of-consumption metrics for member supply chain consumption reporting. Such metrics may provide value to insurers by accurately reporting whether member consumption complies with prescribed dosage.

FIG. 38 illustrates an exemplary workflow for providing real-time point-of-care pharmaceutical efficacy metrics. Such metrics may provide value by comparing the effectiveness of a therapy or treatment with the member's compliance with the prescribed therapy or treatment.

(i) Member Services to Mobile Client Control Devices

For example, wirelessly deactivate insulin pump if blood sugar level decreases below a threshold. This control can be from authorized users or from an autonomous agent.

(ii) User Interface of Information

In addition to screens providing user interface information from data received directly from sensors, interface information for member screens can also come from centrally processed data or others in the member's network. Can include trending info, tips, messages from others, location of others in network (physical location and/or proximity to member).

(iii) Provide Drivers/Software

Can provide drivers/plugins necessary to interact with sensors/monitors/devices. Can update the software/firmware for the same. If the devices have internal thresholds/alarms/etc., can set them.

The disclosed system, therefore, provides a member-centric, decentralized health monitoring system that allows for a trusted care network as well as health providers to monitor data from many members. This allows providers to evaluate trends in data for a member, improve the provider's ability to triage effectively a member in the event that the monitored data indicates the approach or onset of an emergency situation or a negative trend or precipitating event with short or long term negative health impacts. This enables a provider to provide preventative care, such as making sure the member abides by monitoring and medication schedules, maintains nutrition, and the like. The disclosed system also provides Health Service Management including both Event Management and Incentive Management to bring about positive behavioral change in a member.

### (k) Disclosure of Exemplary Computing Device

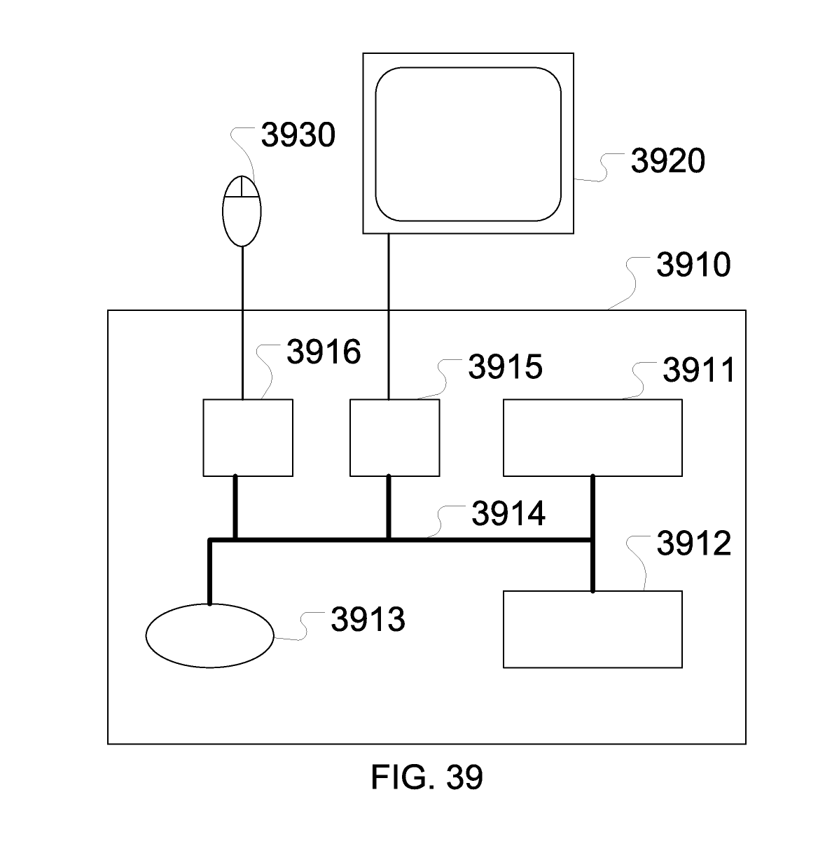

Embodiments disclosed herein may be implemented with software, for example modules executed on computing devices such as computing device 3910 of FIG. 39. Of course, systems, processes, workflows, and the like described herein illustrate various functionalities and do not limit the structure of any embodiments. Rather the functionality may be implemented by any number of modules being configured according to various design considerations.

Computing device 3910 has one or more processing device 3911 designed to process instructions, for example computer readable instructions (i.e., code) stored on a storage device 3913. By processing instructions, processing device 3911 may perform the steps and functions disclosed herein. Storage device 3913 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. Computing device 3910 additionally may have memory 3912, an input controller 3916, and an output controller 3915. A bus 3914 may operatively couple components of computing device 3910, including processor 3911, memory 3912, storage device 3913, input controller 3916, output controller 3915, and any other devices (e.g., network controllers, sound controllers, etc.). Output controller 3915 may be operatively coupled (e.g., via a wired or wireless connection) to a display device 3920 (e.g., a monitor, television, mobile device screen, touch-display, etc.) in such a fashion that output controller 3915 can transform the display on display device 3920 (e.g., in response to modules executed). Input controller 3916 may be operatively coupled (e.g., via a wired or wireless connection) to input device 3930 (e.g., mouse, keyboard, touch-pad, scroll-ball, touch-display, etc.) in such a fashion that input can be received from a user.

Of course, FIG. 39 illustrates computing device 3910, display device 3920, and input device 3930 as separate devices for ease of identification only. Computing device 3910, display device 3920, and input device 3930 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 3910 may be one or more servers, for example a farm of networked servers, a clustered server environment, or a cloud network of computing devices.

As illustrated in some disclosed embodiments, embodiments may utilize decentralized networks of mobile computing devices, such as smartphones or tablets (e.g., iOS devices; Android devices; Windows Mobile devices; HP webOS devices; Palm OS devices; and the like). By deploying embodiments on mobile devices, clients (members and TCT members) can be conveniently alerted and enter small bits of data as needed. This is more convenient that using a special device, such as the special devices utilized by current mHealth solutions.

Of course, alternative embodiments may employ other general purpose or special purpose computing device. For example, embodiments may utilize conventional personal computers. Additionally, as 4G networks, web-TV, and other emerging technologies evolve, new computing and communication devices may be deployed within a CCN disclosed herein.

By utilizing computing devices that a clients generally use in their every-day life, embodiments may receive more accurate data because a member may record perception in real-time rather than from memory (e.g., a person who was depressed before taking their medication may not later remember their mood as better than they originally perceived it). In other words, because a member may confidently interact with their network directly from a computing device that they generally carry on their person (e.g., their smartphone), the member may report relevant heath data more confidently, thus more timely.

Embodiments have been disclosed herein. However, various modifications can be made without departing from the scope of the embodiments as defined by the appended claims and legal equivalents.

1.-124. (canceled)

125. A system for providing continuity of care management, the system comprising:
a member device configured to communicate with one or more remote devices over a network, at least one of the member device and remote devices comprises a health service management computing system, having at least one processor, configured to:
provide a care plan for a user of the member device, the care plan defining a personalized course of care for a health-related condition of the user;
monitor user interaction with the member device and receive a user-related health event from the member device;
determine user compliance in real- or near real-time with the care plan based, at least in part, on a comparison between the received user-related health event and one or more parameters of the care plan;
identify a violation and user non-compliance with the care plan if the comparison falls outside of a defined compliance boundary;
initiate a multi-tiered escalation and workflow process of the care plan in response to the identified violation;
transmit, at a first tier level, an alert of the violation only to the member device;
transmit, at a second tier level, the violation alert to a first remote device associated with a non-healthcare professional in a trusted care network if the violation remains after the first tier level escalation; and
transmit, at a third tier level, the violation alert to a second remote device associated with a healthcare professional if the violation remains after the second tier level escalation.

126. The system of claim 125, wherein the health service management computing system is further configured to monitor, at each tier level, user interaction with the member device for a user-related health event sufficient to overcome the violation.

127. The system of claim 125, wherein the one or more parameters of the care plan are selected from the group consisting of digital consents, therapeutic regimen protocols, physiological vitals, transitional tasks, events, rules, resources, and workflows associated with the course of care.

128. The system of claim 127, wherein the user-related health event is selected from the group consisting of user consent to one or more modifications to the care plan, user characteristics including user medical data, and user actions or inactions related to therapeutic regimen, transitional tasks, behavioral communications, and lifestyle events, or combinations thereof.

129. The system of claim 128, further comprising a sensor communicatively coupled to the member device and configured to monitor user characteristics selected from the group consisting of user physiological characteristics, user vital signs, user blood analysis, and user movement.

130. The system of claim 129, wherein the sensor is selected from the group consisting of a blood glucose monitor, a weight scale, an electrocardiogram, an accelerometer, a three-axis gyroscope, and a global positioning satellite (GPS) module.

131. The system of claim 129, wherein the health service management computing system is further configured to compare sensed user characteristics with a set of defined characteristics associated with the care plan to determine whether sensed user characteristics fall within an acceptable boundary.

132. The system of claim 129, further comprising at least one autonomous agent configured to receive sensed user characteristics data from the sensor and transmit a signal to the member device alerting the user to perform a task associated with the care plan in response to the sensed user characteristics and/or to control a medical device associated with the sensor.

133. The system of claim 125, wherein the health service management computing system is configured to determine context-based content to provide to the user on the member device based on the care plan, received user-related health events, and/or user compliance or non-compliance with the care plan.

134. The system of claim 133, wherein the context-based content is determined based on a time of day, a location of the user, a location of the non-healthcare and/or healthcare professional, and/or location of an additional resource to which the user has subscribed.

135. The system of claim 133, wherein the context-based content comprises information, incentives, and/or services associated with and relevant to the one or more parameters of the care plan, the received user-related health events, and/or user compliance or non-compliance with the care plan.

136. The system of claim 125, wherein the health service management computing system is configured to dynamically determine optimal healthcare services based, at least in part, on a location of the member device in relation to health-related assets and quality of service performance metrics associated with the health-related assets.

137. The system of claim 136, wherein the health-related assets are selected from the group consisting of the non-healthcare professional, the healthcare professional, health care provider resources, and network resources and the quality of service performance metrics is selected from availability and on-time delivery.

138. The system of claim 125, wherein the care plan is based, at least in part, on a health service policy template developed by a third party and provided to a healthcare provider of the user.

139. The system of claim 138, wherein the health service management computing system is configured to require healthcare provider consent to any modifications to the health service policy template resulting in modifications to the care plan.

140. The system of claim 125, wherein the health service management computing system is configured to allow the creation of new care plans or modification of existing care plans and further configured to prompt the user for acknowledgement of and consent to any modifications to the care plan.

141. A system for providing continuity of care management, the system comprising:
a member device configured to communicate with one or more remote devices over a network, at least the member device comprises a health service management computing system, having at least one processor, configured to:
provide a care plan for a user of the member device, the care plan defining a personalized course of care for a health-related condition of the user;
monitor user interaction with the member device and receive a user-related health event from the member device;
determine user compliance in real- or near real-time with the care plan based, at least in part, on a comparison between the received user-related health event and one or more parameters of the care plan;
identify a violation and user non-compliance with the care plan if the comparison falls outside of a defined compliance boundary;
initiate a multi-tiered escalation and workflow process of the care plan in response to the identified violation;
transmit, at a first tier level, an alert of the violation only to the member device;
transmit, at a second tier level, the violation alert to a first remote device associated with a non-healthcare professional in a trusted care network if the violation remains after the first tier level escalation; and
transmit, at a third tier level, the violation alert to a second remote device associated with a healthcare professional if the violation remains after the second tier level escalation; and
a medical device for providing treatment to the user and an associated sensor communicatively coupled to the member device and configured to monitor user characteristics selected from the group consisting of user physiological characteristics, user vital signs, user blood analysis, and user movement;
wherein the health service management computing system is configured to compare sensed user characteristics with a set of defined characteristics associated with the care plan and control operation of the medical device to provide a treatment based on the comparison.

142. A method for providing continuity of care management, the method comprising:
providing a care plan for a user, the care plan defining a personalized course of care for a health-related condition of the user;
monitoring for and receiving a user-related health event;
determining user compliance in real- or near real-time with the care plan based, at least in part, on a comparison between the received user-related health event and one or more parameters of the care plan;
identifying a violation and user non-compliance with the care plan if the comparison falls outside of a defined compliance boundary;
initiating a multi-tiered escalation and workflow process of the care plan in response to the identified violation;
transmitting, at a first tier level, an alert of the violation only to the user;
transmitting, at a second tier level, the violation alert to a non-healthcare professional in a trusted care network as authorized by the user if the violation remains after the first tier level escalation; and
transmitting, at a third tier level, the violation alert to a healthcare professional associated with the user if the violation remains after the second tier level escalation.

143. The method of claim 142, wherein the one or more parameters of the care plan are selected from the group consisting of digital consents, therapeutic regimen protocols, physiological vitals, transitional tasks, events, rules, resources, and workflows associated with the course of care and the user-related health event is selected from the group consisting of user consent to one or more modifications to the care plan, user characteristics including user medical data, and user actions or inactions related to therapeutic regimen, transitional tasks, behavioral communications, and lifestyle events, or combinations thereof.

144. The method of claim 142, further comprising:
determining context-based content to provide to the user based on the care plan, received user-related health events, and/or user compliance or non-compliance with the care plan, the context-based content based on a time of day, a location of the user, a location of the non-healthcare professional and/or healthcare professional, and/or location of an additional resource to which the user has subscribed; and
providing the user with the context-based content, the context-based content comprises information, incentives, and/or services associated with and relevant to the one or more parameters of the care plan, the received user-related health events, and/or user compliance or non-compliance with the care plan.
